(19) United States
(12) Patent Application Publication
(10) Pub. No.: US 2006/0068890 A1
(43) Pub. Date: Mar. 30, 2006

(54) Game system

(75) Inventor: Kazuo Okada, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 11/236,580

(22) Filed: Sep. 28, 2005

(30) Foreign Application Priority Data
Sep. 30, 2004 (JP) 2004-287837
Sep. 30, 2004 (JP) 2004-287816

(51) Int. Cl. A63F 13/00

(52) U.S. Cl. 463/20

(57) ABSTRACT

A game system which can feed a game item to a player in various feed forms is provided. In a game system according to the invention, a communication processing part of a game machine sends an ejection instruction to a communication processing part of a figure feeder. Thus, a figure can be fed in various feed forms not only in the case where a figure purchase instruction is accepted from a player to sell the figure but also in the case where a predetermined condition is held on a labyrinth combat game.

### CROSS REFERENCE TO RELATED APPLICATIONS

The present application is based on and claims priority of Japanese patent applications No. 2004-287816 and No. 2004-287837 both filed on Sep. 30, 2004, the entire contents of which are hereby incorporated by reference.

### BACKGROUND OF THE INVENTION

1. Field of the Invention

The present invention relates to a game system which plays a game using game items such as figures, cards and cassettes.

2. Background Art

Traditionally, a game machine is known that can use game items such as figures, cards and cassettes for use in a game to play games. For example, Patent Reference 1 discloses a card game machine that has a portion (reading portion) which reads data on multiple cards placed on a play field and a portion which displays an image in accordance with the read data in which an image corresponding to the combination of multiple cards arranged by a player is displayed to simulate team play. In this card game machine, a new card is offered to the player after the game (match).

However, when a game item is offered after the game is finished as described above, a player who first plays that game machine needs to obtain the game item beforehand at somewhere else before beginning the game. Therefore, when a player does not know how or where to obtain the game item, the player cannot play the game.

Then, Patent Reference 2 discloses a game system that has a game machine (play machine) equipped with a display device and a capsule vendor (game item feeder). In this game system, a player can purchase a capsule containing a figure (game item) from the game item feeder equipped on the game machine when starting a game using the game item on the game machine.

[Patent Reference 1] JP-A-2002-301264

[Patent Reference 2] JP-A-2002-153675

### SUMMARY OF THE INVENTION

However, the traditional game system described above has problems below. More specifically, the game item feeder of the traditional game system simply sells game items, and the player only has a way to purchase a game item from the game item feeder in order to obtain the game item.

In addition to this, in the traditional game system, it cannot selectively offer a particular type of game item to the player among several types of game items

Then, an object of the invention is to provide a game system which can solve the problems.

[Means for Solving the Problems]

A game system according to the invention is characterized by including:

a game item feeder having:

a housing unit which houses a game item storing identification information; and

an ejection unit which discharges the game item, and

a game machine which reads identification information from the game item and plays an image game using a game image corresponding to the game item,

wherein the game machine includes:

a sending portion which sends an ejection instruction of the game item to the game item feeder, and

the game item feeder includes:

a receiving portion which receives the ejection instruction from the game machine; and

an ejection control portion which allows the ejection unit to discharge the game item when the receiving portion receives the ejection instruction.

In this game system, the sending portion of the game machine sends the ejection instruction of the game item to the game item feeder. When the receiving portion of the game item feeder receives the ejection instruction, the ejection control portion of the game item feeder allows the ejection unit to discharge the game item. Therefore, for example, in the cases where the game machine accepts a predetermined instruction from a player, and the case where a predetermined condition is held in game progress, the sending portion sends the ejection instruction to the game item feeder, and thus various feed forms of the game item can be implemented.

In the game system, the housing unit of the game item feeder may have multiple housing parts which house the game item, and the ejection instruction sent by the sending portion of the game machine may include housing part identification information that identifies a specific housing part among the multiple housing parts.

In this game system, the sending portion of the game machine sends the ejection instruction including housing part identification information to the game item feeder. When the receiving portion of the game item feeder receives the ejection instruction, the ejection control portion of the game item feeder discharges the game item housed in the housing part specified by housing part identification information included in the ejection instruction. Therefore, different types of the game items are housed in the individual housing parts of the ejection unit of the game item feeder, and then the game item feeder can selectively discharge the game item in the housing part specified by housing part identification information. Accordingly, the types of the game items housed in each of the housing parts are associated with housing part identification information about each of the housing parts, and thus the game item feeder can selectively provide a particular type of game item for the player.

Furthermore, preferably, the game machine further includes an accepting portion which accepts a feed instruction of the game item from a player, and the sending portion of the game machine sends the ejection instruction to the game item feeder based on acceptance of the feed instruction by the accepting portion. In this case, the game item can be offered to the player who desires the game item.

Moreover, the accepting portion may accept a feed instruction of the game item including the housing part identification information from a player, and the sending portion of the game machine may send the ejection instruction of the game item including the housing part identification information to the game item feeder based on acceptance of the feed instruction by the accepting portion. In this case, the type of the game item that the player desires can be offered.

Besides, preferably, the game machine further includes a game progress control portion which controls progress of the image game, the game progress control portion inputs instruction information indicating a feed instruction of the game item to the sending portion based on establishment of a predetermined condition in game progress, and the sending portion sends the ejection instruction to the game item feeder based on input of the instruction information from the game progress control portion. In this case, the game item can be offered to the player as a bonus that a predetermined condition is held in game progress.

Furthermore, instruction information may include the housing part identification information and indicate a feed instruction of the game item based on establishment of a predetermined condition in game progress. The sending portion may send the ejection instruction of the game item including the housing part identification information to the game item feeder. In this case, a particular type of game item can be offered to the player as a bonus that a predetermined condition is held in game progress.

Moreover, preferably, instruction information may include housing part identification information of the housing part which houses the game item corresponding to a predetermined condition among the multiple housing parts. In this case, the game item corresponding to a predetermined condition can be offered to the player as a bonus that that predetermined condition is held in game progress.

According to the invention, the game system can be provided which can supply game items to the player in various feed forms.

### BRIEF DESCRIPTION OF THE DRAWINGS

The teaching of the invention can beadily understood by considering the following detailed description in conjunction with the accompanying drawings, in which

FIG. 1 is a diagram illustrating the system configuration of a network system having multiple game machines according to the invention;

FIG. 2 is a perspective view illustrating multiple game machines, a card vending machine and a figure feeder;

FIG. 3 is a perspective view illustrating the overall configuration of the game machine;

FIG. 4 is a diagram of the game machine mainly illustrating the internal configuration thereof;

FIG. 5 is a diagram illustrating an exemplary internal configuration of an image control circuit;

FIG. 6 is a diagram illustrating a store server;

FIG. 7 is an exploded perspective view illustrating the configuration of a figure;

FIG. 8 is a perspective view illustrating the overall configuration of the figure feeder;

FIG. 9 is a perspective view illustrating the figure feeder partially exploded;

FIG. 10 is a side view schematically illustrating the essential part of the figure feeder;

FIG. 11 is a diagram of the figure feeder mainly illustrating the internal configuration thereof;

FIG. 12 is a diagram illustrating a game server and a database server;

FIG. 13 is a flow chart illustrating the operation procedures of a game process in the game machine from the start to the end of the game;

FIG. 14 is a flow chart illustrating the operation procedures of a figure employed game process;

FIG. 15 is a flow chart illustrating the operation procedures of a no-figure employed game process;

FIG. 16 is a flow chart illustrating the operation procedures of a shift phase process;

FIG. 17 is a flow chart illustrating the operation procedures of a move phase process;

FIG. 18 is a flow chart illustrating the operation procedures of a game start process;

FIG. 19 is a flow chart illustrating the operation procedures of a character creation process;

FIG. 20 is a sequence chart illustrating operation sequences done among the game machines, the store servers and center servers;

FIG. 21 is a flow chart illustrating the details of operation of the figure feeder;

FIG. 22 is a flow chart illustrating the details of operation of the figure feeder;

FIG. 23 is a diagram illustrating a group code table;

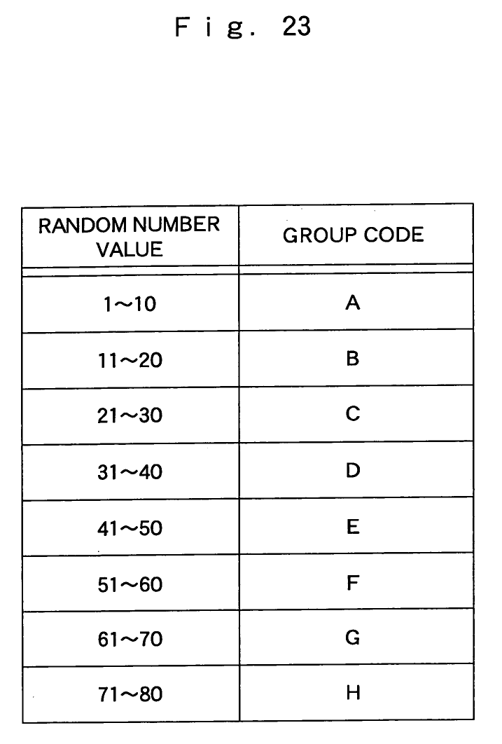

FIG. 24 is a diagram illustrating a labyrinth image;

FIG. 25 is a diagram illustrating another labyrinth image;

FIG. 26 is a diagram illustrating a combat select image; and

FIG. 27 is a diagram illustrating a combat image.

### DESCRIPTION OF THE PREFERRED EMBODIMENT

Hereinafter, an embodiment that is considered to be the best for implementing the game system according to the invention will be described in detail with reference to the accompanying drawings. In addition, the same or equivalent component is designated the same numerals and signs, omitting the description when it is overlapped (the overall configuration of a network system).

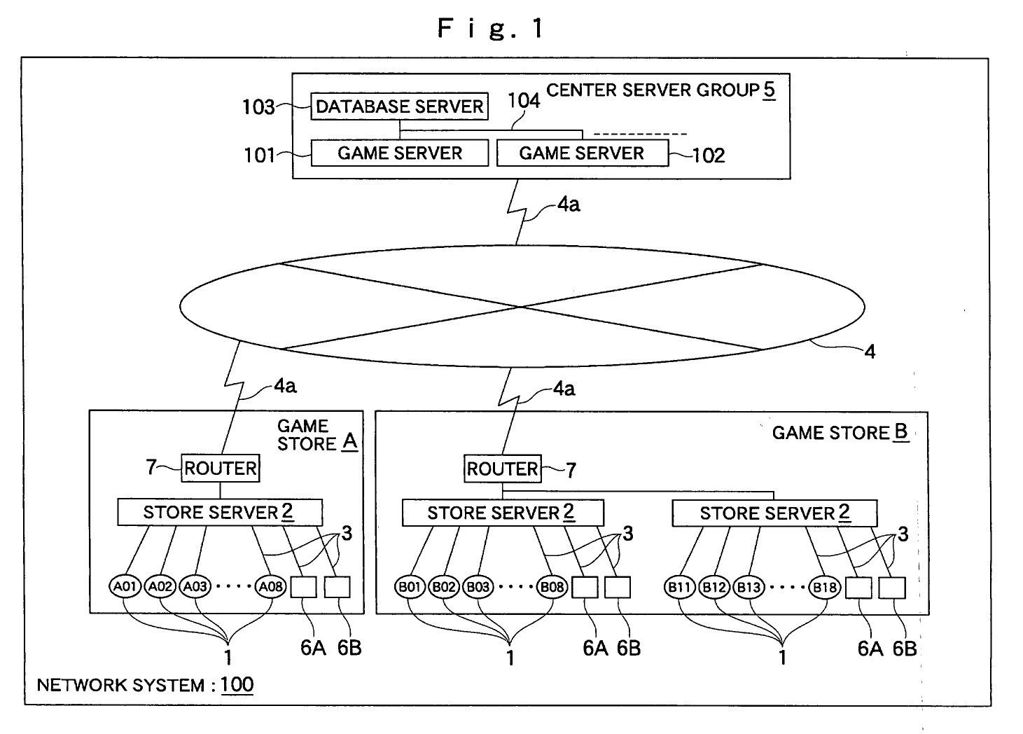

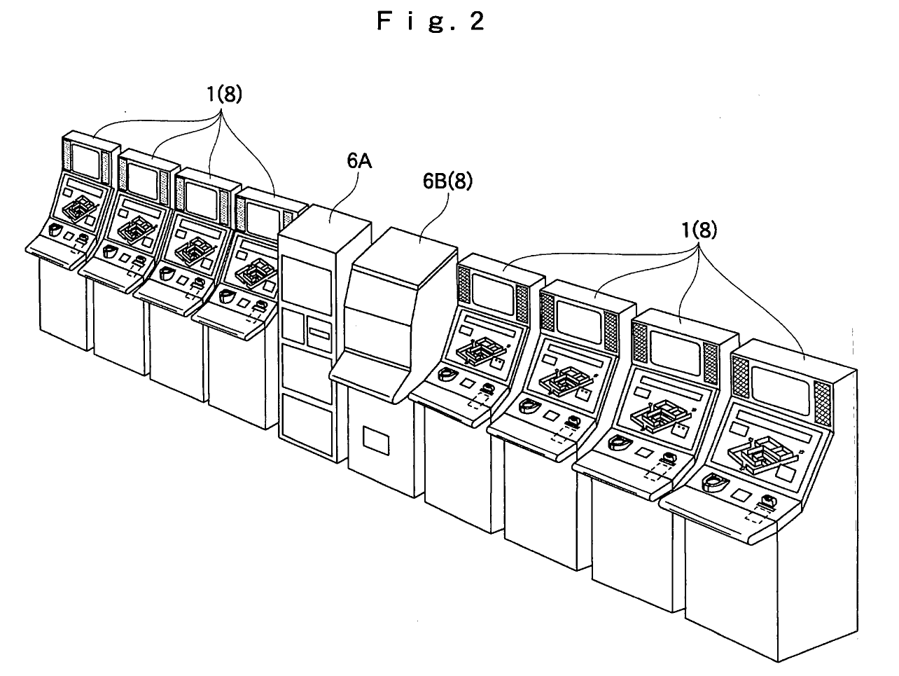

FIG. 1 is a diagram illustrating the system configuration of a network system 100 having multiple game machines 1 according to the invention, and FIG. 2 is a perspective view illustrating multiple game machines 1, a card vending machine 6A, and a figure feeder (game item feeder) 6B. The network system 100 has three store servers 2 in total which are placed in two game stores A and B, one is disposed in the game store A and two are disposed in the game store B, multiple game machines 1 (eight machines in the embodiment) which can communicate through dedicated lines 3, the card vending machine 6A and the figure feeder 6B, an in-store router 7 placed in the game stores A and B, and a center server group 5 which is connected through the in-store router 7, communication lines 4a and the Internet 4.

In each of the game stores A and B, the store server 2, the game machines 1, the card vending machine 6A and the figure feeder 6B are connected by the dedicated lines 3 to form an in-store LAN (Local Area Network), and the in-store LAN is connected to the Internet 4 through the in-store router 7. In addition, the game system 8 according to the invention is configured of the game machines 1 and the figure feeder 6B connected as they can communicate (the configuration of the game machine).

The game machine 1 is a game machine of the embodiment according to the invention, having an image display portion which displays a character image expressing a character (the detail will be described later) that acts as a game image for use in a game in accordance with manipulations by a player, the game machine is configured to run an image game that the character is operated in accordance with the manipulations by the player. In the game machine 1 of the embodiment, a game can be played in which the character moves in a labyrinth along a route selected by the player, fights against the other characters other than that player (a player character operated in accordance with the select by another player, and non-player characters operated by the game machine), and scrambles for items held by the characters (orbs in the embodiment), collects all the items, and defeats a character of the final target (hereinafter, it is called a “labyrinth combat game”). In the labyrinth combat game, the scores of each of the characters (it is called “life” in the embodiment) is increased and decreased in accordance with the combat result and the progress situations in the game, and the character who has no scores becomes a loser.

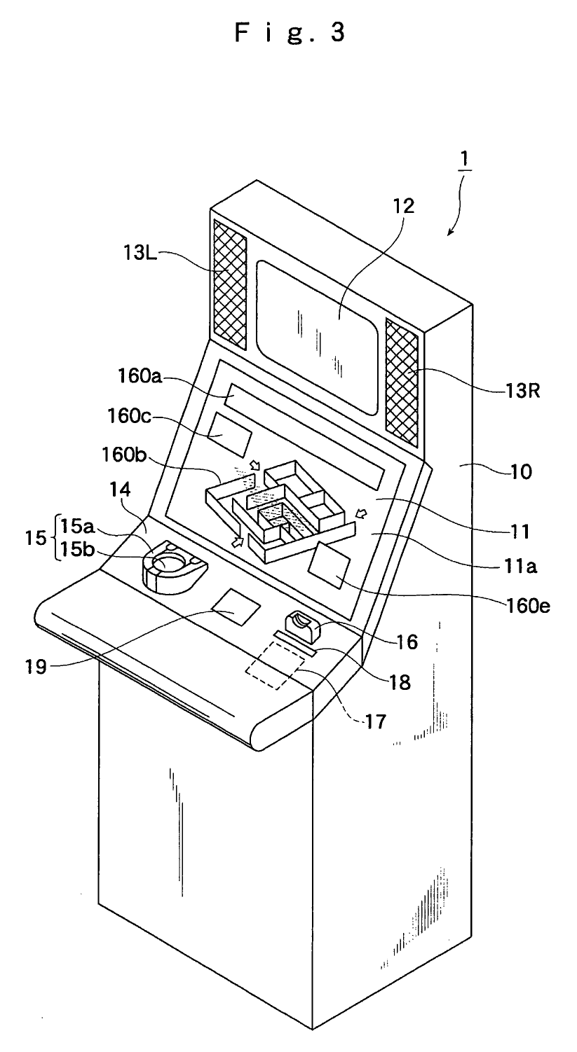

As shown in FIG. 3, the game machine 1 has a main display 11 equipped with a liquid crystal display device in the front side of a housing 10. Furthermore, it has a sub-display 12 similarly equipped with a liquid crystal display device in the upper side of the main display 11, and speakers 13L and 13R which output sounds used for directing the game on the right and left sides.

On the main display 11, game images (for example, a labyrinth image 160, described later) are displayed in accordance with the individual stages of the game. On the sub-display 12, images (for example, a combat image 180, described later) are displayed in the specific stage of the game.

Moreover, the game machine 1 has a control panel 14 on the lower side of the main display 11. An authentication unit 15 is disposed on the left side of the control panel 14. The panel has a coin input port 16 into which a coin (a game medium such as a coin and a game medal) required for playing the game and a card slot 18 into which an ID card 17 is inserted on the right side, and has a control unit 19 equipped with control buttons.

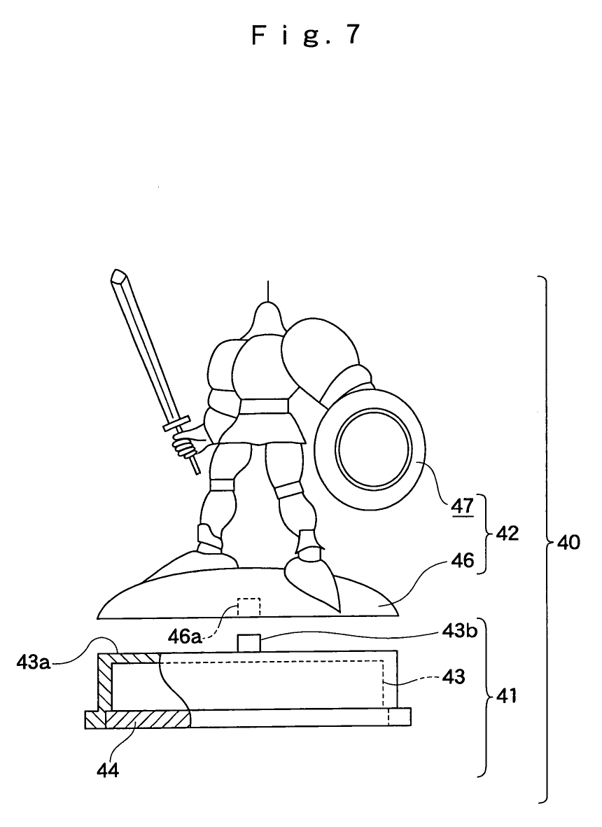

The authentication unit 15 has a base mount part 15a fixed to the surface of the control panel 14 and a reading part 15b. The base mount part 15a has a thick disk-like recess corresponding to the shape of a base part 41 of a figure 40 (see FIG. 7), described later, inside thereof, and the base part 41 can be fit and mounted on the recess. The reading part 15b is placed in the recess of the base mount part 15a, having an IC chip reader, not shown, and the IC chip reader reads recorded information out of an IC chip 44 built in the base part 41 of the figure 40 mounted. In addition, the authentication unit 15 has an LED that irradiates light onto the figure during the read of the figure 40, described later.

To each of the game machines 1 configuring the network system 100, a machine ID unique to that machine is assigned. The machine ID has a server ID unique to the individual store servers 2 and an ID unique to the individual game machines 1. For example, in the case of the individual game machines 1 placed in the store A, IDs are A01, A02, A03 and so on.

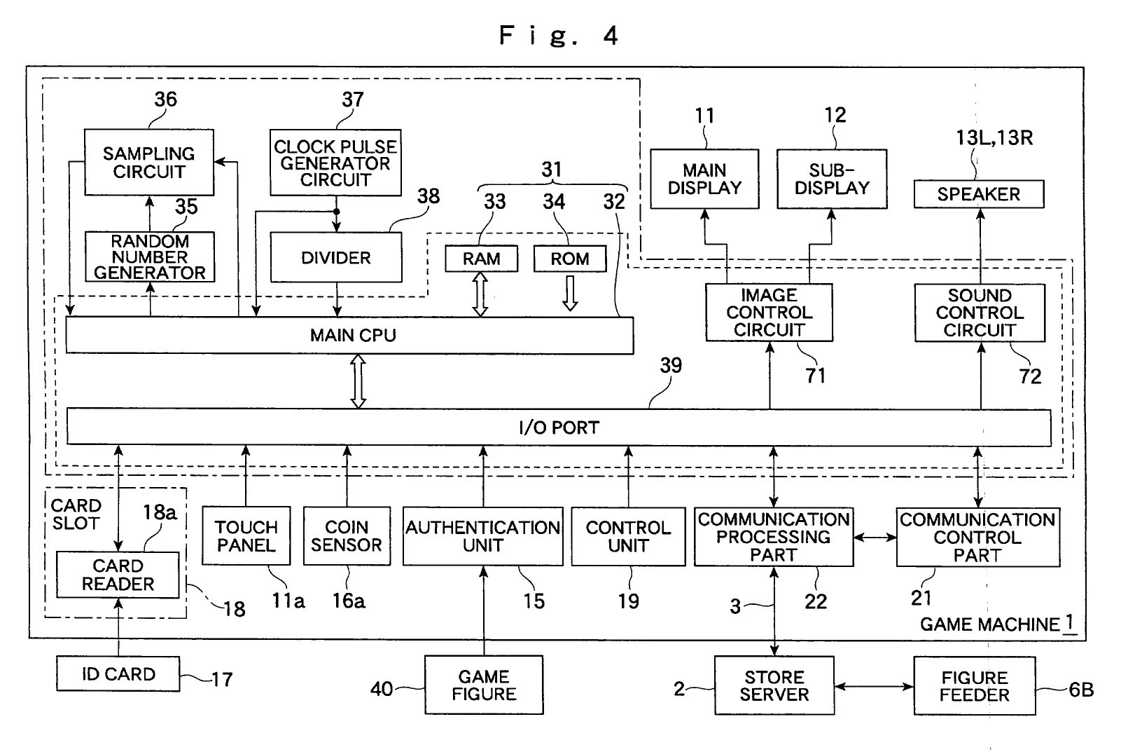

FIG. 4 is a diagram of the game machine 1 mainly illustrating the internal configuration thereof. The game machine 1 has multiple components as the microcomputer 31 is centered.

The microcomputer 31 has a main CPU (Central Processing Unit) 32, RAM (Random Access Memory) 33, and ROM (Read Only Memory) 34. The main CPU 32 is operated in accordance with a program stored in the ROM 34, it inputs signals from each component disposed on the control panel 14 through an I/O port 39 as well as inputs and outputs signals from the other components to control the entire operation of the game machine 1. The RAM 33 stores data (application data and game data described later, in the embodiment) and programs used in operation of the main CPU 32. The ROM 34 stores a control program run by the main CPU 32 and permanent data.

Furthermore, the game machine 1 has a random number generator 35, a sampling circuit 36, a clock pulse generator circuit 37, and a divider 38. The random number generator 35 is operated in accordance with the instruction of the main CPU 32 to generate random numbers in a fixed range. The sampling circuit 36 extracts a given random number among the random numbers generated by the random number generator 35 in accordance with the instruction of the main CPU 32 to input the extracted random number to the main CPU 32. The clock pulse generator circuit 37 generates a reference clock for operating the main CPU 32, and the divider 38 inputs the signal that the reference clock is divided by a fixed cycle to the main CPU 32.

Moreover, the game machine 1 has a touch panel 11a, a coin sensor 16a, a card reader 18a, a communication control part 21 and a communication processing part (sending portion) 22, and further has an image control circuit 71 and a sound control circuit 72.

The touch panel 11a is disposed so as to cover a display screen of the main display 11, which detects the position of the place where the player's finger is touched, and inputs a position signal corresponding to the detected position to the main CPU 32. The player uses the touch panel 11a to make operation input for determining the action of the character. For example, the touch panel 11a has a conductive material applied onto the surface of a rectangular transparent plate. Voltage is applied from electrodes disposed at four corners of the transparent plate, detects a minute current change caused by the touch of the player's finger through the electrodes, and detects the position of the place where the player's finger is touched.

The coin sensor 16a detects a coin inputted from the coin input port 16, and outputs a detection signal corresponding to the detection to the main CPU 32. The card reader 18a reads card information such as a player ID recorded in the ID card 17 inserted into the card slot 18, and inputs the read card information to the main CPU 32.

The communication control part 21 is operated in accordance with the instruction of the main CPU 32, and controls connecting and disconnecting the lines for communicating with the store server 2. The communication processing part 22 is operated in accordance with the instruction of the communication control part 21 to send and receive data through the dedicated lines 3.

The image control circuit 71 controls image display over both of the main display 11 and the sub-display 12, and displays various images such as an image expressing the character on the main display 11 and the sub-display 12.

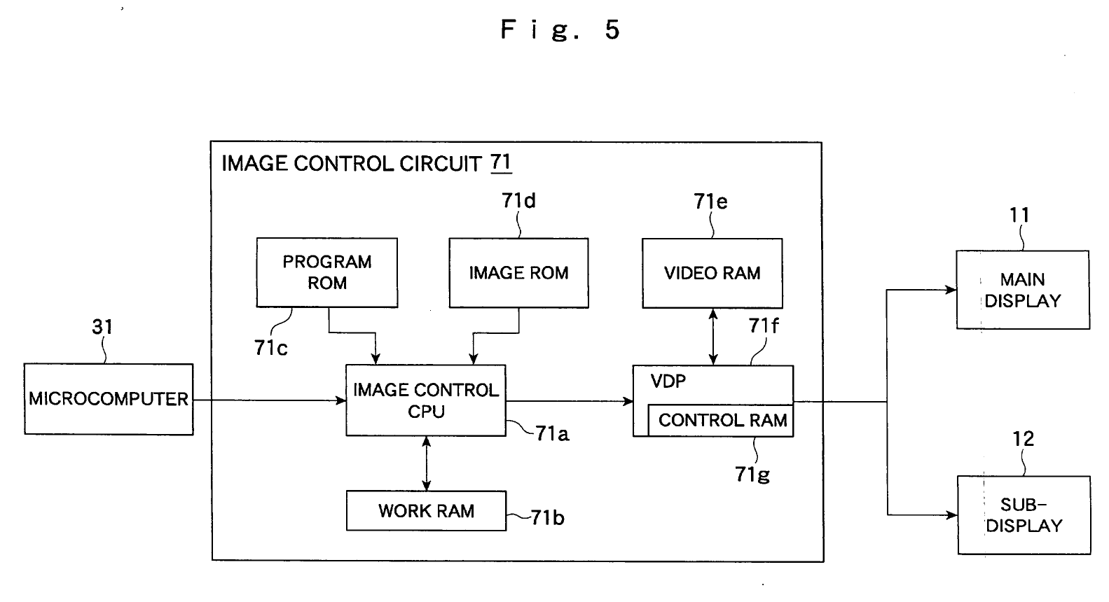

As shown in FIG. 5, the image control circuit 71 has an image control CPU 71a, work RAM 71b, program ROM 71c, image ROM 71d, video RAM 71e, and a VDP (Video Display Processor) 71f. The image control CPU 71a decides images displayed on the main display 11 and the sub-display 12 in accordance with an image control program stored beforehand in the program ROM 71c (relating to display on the main display 11 and the sub-display 12) based on parameters set by the microcomputer 31. The work RAM 71b is configured as a temporary storage portion when the image control CPU 71a runs the image control program.

The program ROM 71c stores the image control program and various select tables. The image ROM 71d stores dot data for forming an image. The video RAM 71e is configured as a temporary storage portion when the VDP 71f forms an image. The VDP 71f has control RAM 71g, forms an image in accordance with display details of the main display 11 and the sub-display 12 decided by the image control CPU 71a, and outputs the individual images to the main display 11 and the sub-display 12.

The sound control circuit 72 inputs sound signals for outputting sounds from the speakers 13L and 13R to the speakers 13L and 13R. From the speakers 13L and 13R, for example, after starting the game, sounds to augment the game are outputted at a proper timing (the configuration of the store server, the card vending machine, and the in-store router).

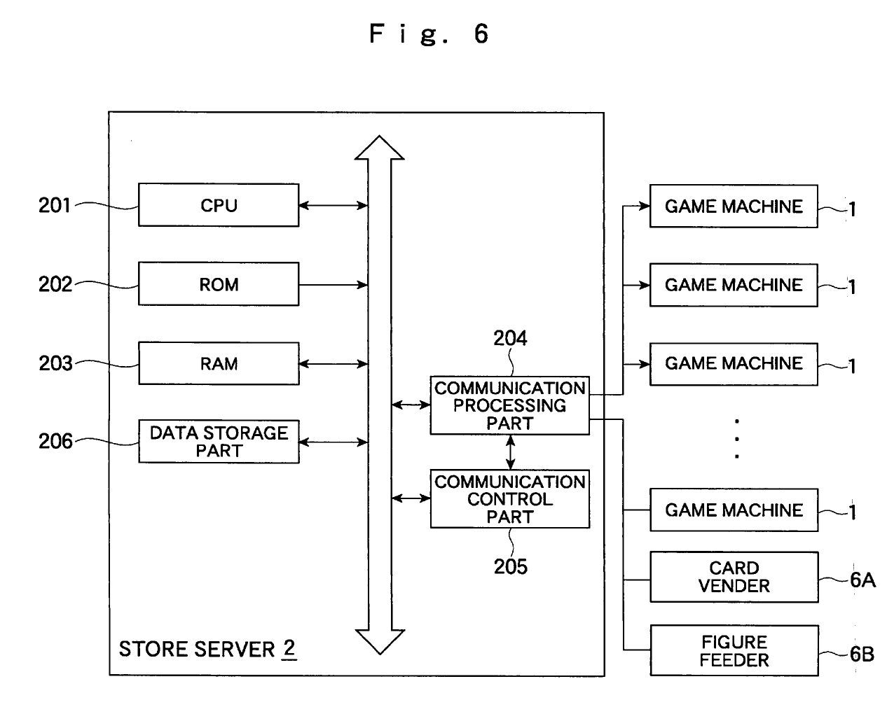

As shown in FIG. 6, the store server 2 has a CPU 201, ROM 202, RAM 203, a communication processing part (communication portion) 204, a communication control part 205 and a data storage part 206 stored with application data. Then, the CPU 201 is operated as well as reads and writes data to the RAM 203 in accordance with a program stored in the ROM 202, whereas the communication control part 205 operates the communication processing part 204 in accordance with the instruction of the CPU 201. Then, the store server 2 sends and receives data with each of the game machines 1, the card vending machine 6A and the figure feeder 6B disposed in each of the game stores A and B through the dedicated lines 3. The store server 2 sends and receives (downloads) application data to each of the game machines 1, and relays sending and receiving data between each of the game machines 1 and with the center server group 5. The application data contains various items of data (image data for the game) used for a labyrinth combat game played in the game machine 1 and board data (a setting program for associating the control buttons equipped on the control unit 19 with the labyrinth combat game).

The card vending machine 6A has an operation part that the player makes input operation of personal information and a card issuing portion in which the card issuing portion allows storage of card information including the player ID unique to the individual players by a predetermined input operation with the operation part, and issues the ID card 17.

The in-store router 7 connects the in-store LAN formed in each of the game stores A and B to a LAN formed in the center server group 5 through the communication line 4a and the Internet 4 (the configuration of the figure).

Here, prior to explaining the figure feeder 6B, the figure 40 fed by the figure feeder 6B will be described with reference to FIG. 7. Here, FIG. 7 is an exploded perspective view illustrating the configuration of the figure 40. The figure 40 has the base part 41, and a figure main body part 42 expressing the three-dimensional form of each of the characters shown in the labyrinth combat game.

The base part 41 has the size corresponding to the recess of the base mount part 15a, which is formed into a hollow thick disk shape. The base part 41 is configured to have a bottomed cylindrical base main body part 43 with a top part 43a and the IC chip 44, in which the IC chip 44 is fit and fixed to the open end part of the base main body part 43. Furthermore, it has a projection 43b nearly at the center of the top part 43a of the base main body part 43. The IC chip 44 stores a figure ID unique to the character corresponding to the figure main body part 42. The figure ID is unique to the figure 40 so as to identify the individual figures, including group codes that show figure groups A to H. For example, the figure IDs of figures belonging to the figure group A are “A001”, “A002”, “A003” and so on; the code at a first digit indicates the figure group, and the lower three digits indicate the code for specifying the figures.

The figure main body part 42 has a foot base part 46 having a recess 46a corresponding to the projection 43b, and a doll part 47 which is formed so as to erect on two feet from the foot base part 46 and shapes each of the characters shown in the labyrinth combat game in which the projection 43b is fit into the recess 46a and fixed to the top part 43a of the base part 41. Furthermore, in the figure 40, color is slightly changed even in the same character, or data unique to the character featuring each of the characters is changed to represent the characteristic property of the characters, and thus the player's willingness to collect figures is promoted. The figure 40 is put in a capsule 47 and housed in a housing unit 53 of the figure feeder 6B. The figure 40 in the capsule 47 housed in the housing unit 53 is the housed game item according to the invention. The player can distinguish figures 40 in accordance with the shape of the figure main body part 42, and the game machine 1 can identify the figures by the figure ID. The figure ID is unique to different figures 40 to inhibit multiple registrations of the same figure in the network system 100.

The capsule 47 has two half-spherical parts that can be separated into two and combined together for a sphere. When the two half-spherical parts are combined, a hollow sphere having a diameter of about seven cm is obtained to house the figure 40 therein (the configuration of the figure feeder).

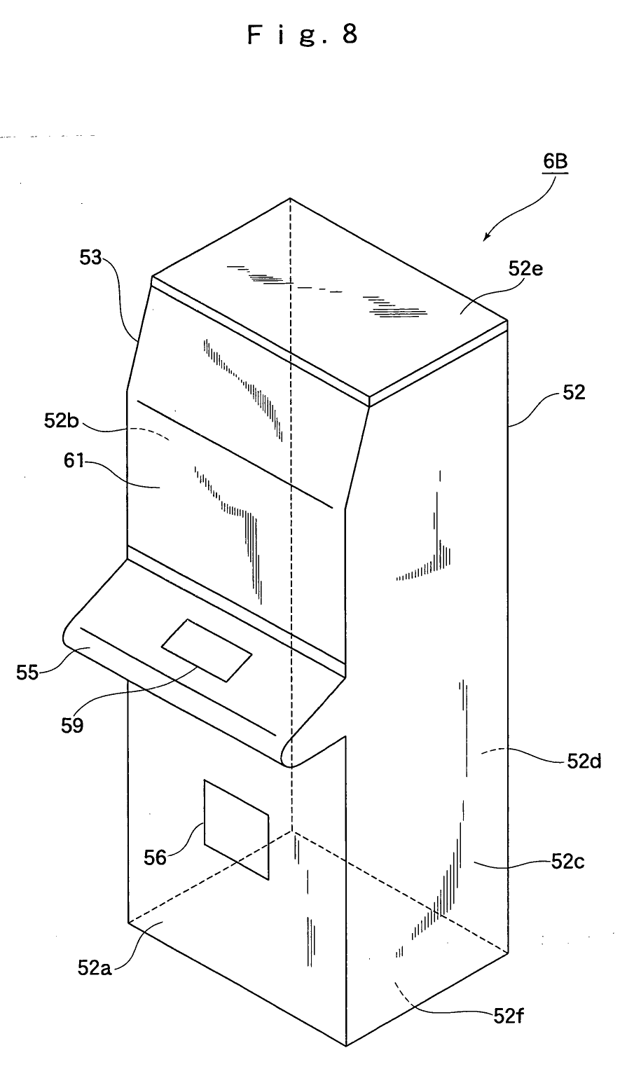

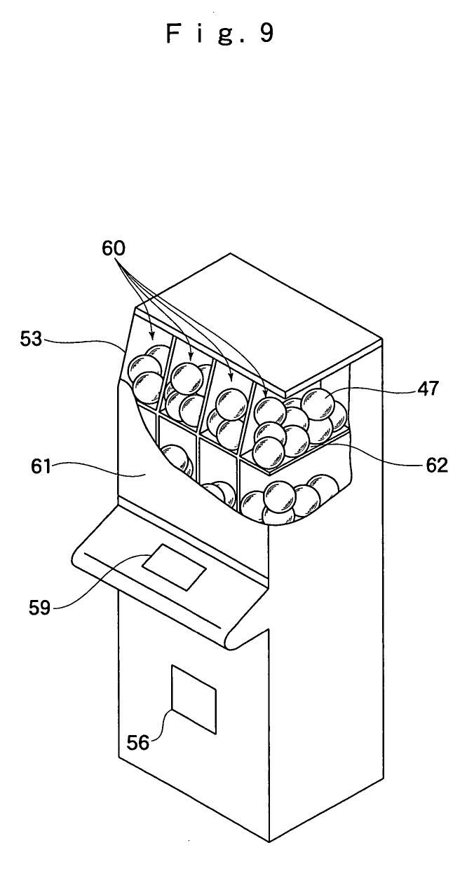

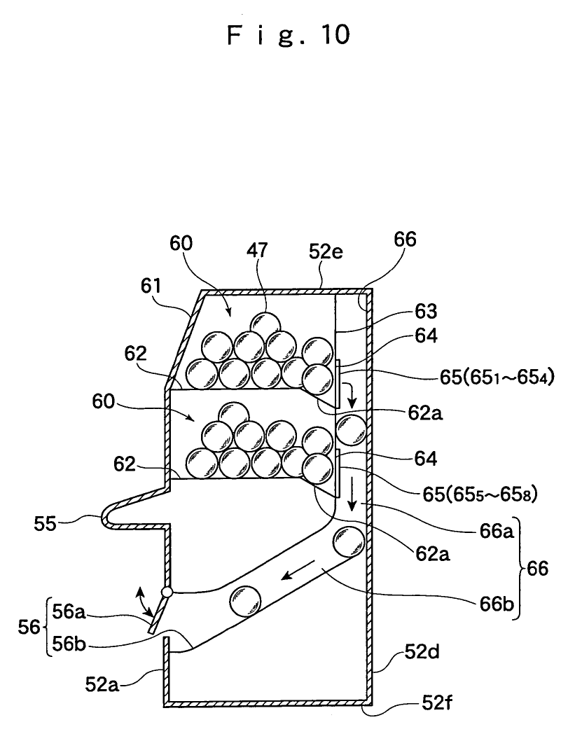

Subsequently, the figure feeder 6B will be described with reference to FIGS. 8 to 10. FIG. 8 is a perspective view illustrating the overall configuration of the figure feeder 6B. FIG. 9 is a perspective view illustrating the figure feeder 6B partially exploded. FIG. 10 is a side view schematically illustrating the essential part of the figure feeder 6B. The figure feeder 6B has the configuration in which the capsule 47 containing the figure 40 is discharged to supply the figure 40 in the capsule 47 to the player.

The figure feeder 6B has a housing 52, a housing unit 53 equipped with multiple housing parts 60 (eight in the embodiment) housed with the proper number of the capsules 47 containing the figures 40, and an ejection unit 54 which discharges the capsule 47 from each of the housing parts 60. In addition, a single figure 40 is contained in the capsule 47 housed in the housing part 60. The figure 40 is used in the game machine 1 which can play an image game that allows the character to move in accordance with the manipulations of the player.

The housing 52 has a front panel 52a forming the front lower side part of the figure feeder 6B, side panels 52b and 52c, a back panel 52d, a top panel 52e, and an under panel 52f. Moreover, the housing 52 is mounted with a transparent panel 61, described later, surrounded by the upper part of the front panel 52a, the side panels 52b and 52c, and the top panel 52e, having a substantially rectangular parallelepiped. Then, the housing 52 has a control panel 55 between the front panel 52a and the transparent panel 61, the control panel 55 is vertically placed nearly at the center and extended frontward. Furthermore, a capsule output port 56 is formed in the front panel 52a. Moreover, in the housing 52, a chute 66 is secured between the back plate 63, described later, and the back panel 52d.

As shown in FIG. 10, the capsule output port 56 has a door 56a which is lifted frontward and openable, and a holding part 56b which receives the capsule 47 discharged from the housing part 60. The capsule output port 56 is formed to take out the capsule 47 held in the holding part 56b by lifting the door 56a from the outside of the housing 52 by the player.

The control panel 55 has a display 59, and the display 59 has a liquid crystal display device. On the display 59, information showing the operation status of the figure feeder 6B is displayed.

As shown in FIGS. 9 and 10, the housing unit 53 is vertically separated into largely two stages by a partition plate 62, and housing parts 60 sectioned into four parts are arranged in each stage, having eight housing parts 60. Each of the housing parts 60 is sectioned into the size that can house multiple capsules 47. Furthermore, the front side of each of the housing parts 60 is formed of a transparent material such as acrylic and glass, and is covered with a transparent panel 61 which is openable by a hinge, not shown, and the capsules 47 housed therein can be visually seen. In addition, the partition plate 62 has a slope 62a that the part close to the back panel 52d is tilted toward the back side.

For each of the housing parts 60; the transparent panel 61 is opened to do work such as adding and changing capsules 47 from the front side of the figure feeder 6B. Moreover, figures 40 belonging to one group among the groups categorized into eight groups are housed in each of the housing parts 60 (in the embodiment, the figures 40 represent eight kinds of the characters shown in the game machine 1, and the figures 40 belonging to each group (figure group) are the same but costumes and arms that the figures wear are different). More specifically, the figures 40 belonging to the same group are housed in the same housing part 60, and the figures 40 in the different figure groups are housed in the other housing parts 60. Then, marks and titles indicating the figure group of the housed figures 40 are shown on the partition plate 62 and the back plate 63, and a store attendant of the game floor refers to the marks and titles to add and change the relevant figure 40. In addition, in the embodiment, the individual figures are considered to belong to any one of the eight figure groups A to H.

Then, the housing unit 53 has the back plate 63 almost vertically erected on the back side of each of the housing parts 60, and the back plate 63 controls the movement of the capsule 47 toward the back side direction. The back plate 63 has eight discharge ports 64 corresponding to each of the housing parts 60. Each of the discharge ports 64 is usually closed by a block plate 65, described later, the block plate 65 is moved to open the port when the capsule 47 is discharged, and the port is connected to the chute 66. The chute 66 has a collection path 66a between the back plate 63 and the back panel 52d, and a common path 66b which connects from the collection path 66a to the capsule output port 56 and is secured on the back side more than the back plate 63 in the housing 52.

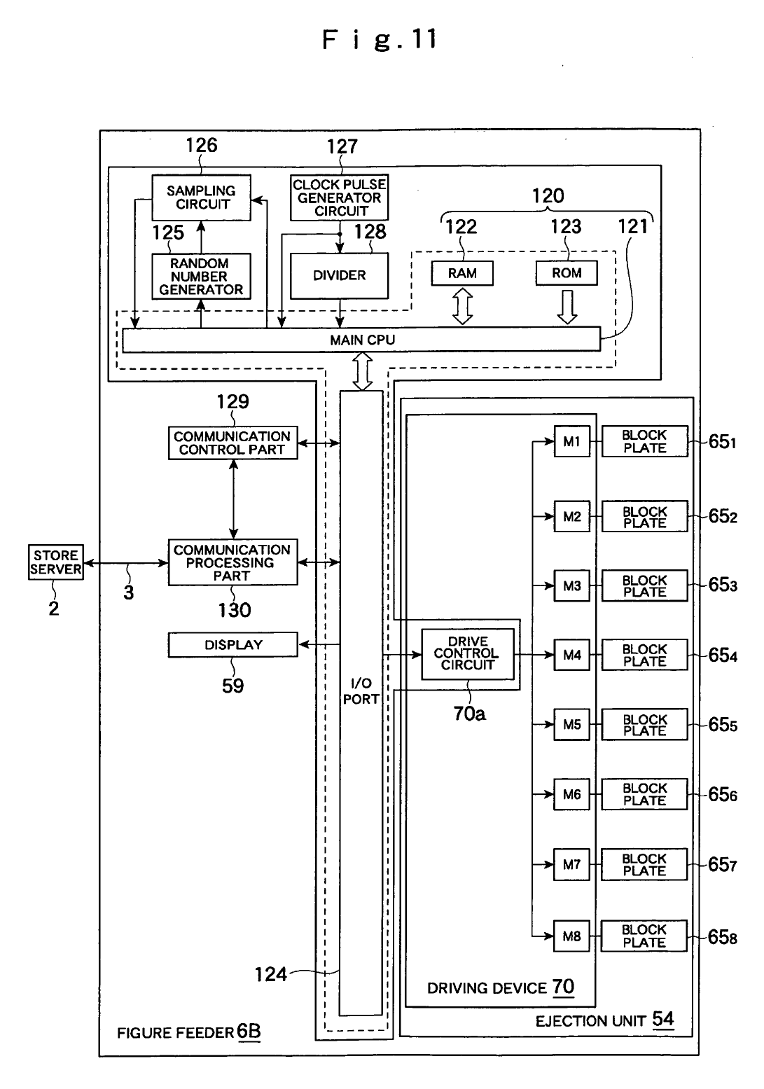

The ejection unit 54 has eight block plates 65 (651 to 658) disposed as correspond to each of the housing parts 60, and a driving device 70 which drives each of the block plates 65 (see FIG. 11). Each of the block plates 65 has the size that can close each of the discharge ports 64 and is individually slid along a guide rail, not shown, for opening and closing by the driving device 70.

Here, FIG. 11 is a diagram mainly illustrating the internal configuration of the figure feeder 6B. The figure feeder 6B has multiple components as a microcomputer 120 is centered.

The microcomputer 120 has a main CPU 121, RAM 122, and ROM 123. The main CPU 121 is operated in accordance with a program stored in the ROM 123 to control each component of the figure feeder 6B through an I/O port 124. The RAM 122 stores data and programs used in operation of the main CPU 121. The ROM 123 stores a control program run by the main CPU 121 and permanent data.

In addition, the figure feeder 6B has a random number generator 125, a sampling circuit 126, a clock pulse generator circuit 127, and a divider 128. The random number generator 125 is operated in accordance with the instruction of the main CPU 121 to generate random numbers in a fixed range. The sampling circuit 126 extracts a given random number among the random numbers generated by the random number generator 125 in accordance with the instruction of the main CPU 121, and inputs the extracted random number to the main CPU 121. The clock pulse generator circuit 127 generates a reference clock for operating the main CPU 121, and the divider 128 inputs a signal that the reference clock is divided by a fixed cycle to the main CPU 121.

Furthermore, the figure feeder 6B has the driving device 70. The driving device 70 has motors M1 to M8 which generate power for sliding each of the block plates 65 (651 to 658) along a guide rail, and a drive mechanism (not shown) which transmits the power of the motors M1 to M8 to each of the block plates 65, and further has a drive control circuit 70a. The motors M1 to M8 are individually operated by drive signals outputted from the drive control circuit 70a, and input power to the drive mechanism. The drive mechanism transmits the power inputted from the motors M1 to M8 to each of the block plates 651 to 658, and slides each of the block plates 651 to 658 along the guide rail. The drive control circuit 70a outputs the drive signals to the corresponding motors M1 to M8 in accordance with control signals outputted from the main CPU 121.

Moreover, the figure feeder 6B has a communication control part 129 which is operated in accordance with the instruction of the main CPU 121 to control connecting and disconnecting the lines for communicating with the store server 2, and a communication processing part 130 which is operated in accordance with the instruction of the communication control part 129 to send and receive data through the dedicated lines 3 (the configuration of the center server group).

The center server group 5 has multiple game servers (two game servers 101 and 102 in FIG. 1) disposed as correspond to each game and a database server 103 in which each of the game servers is connected to each other through the dedicated line 104 to from a LAN, and the LAN is connected to the Internet 4 through a router, not shown.

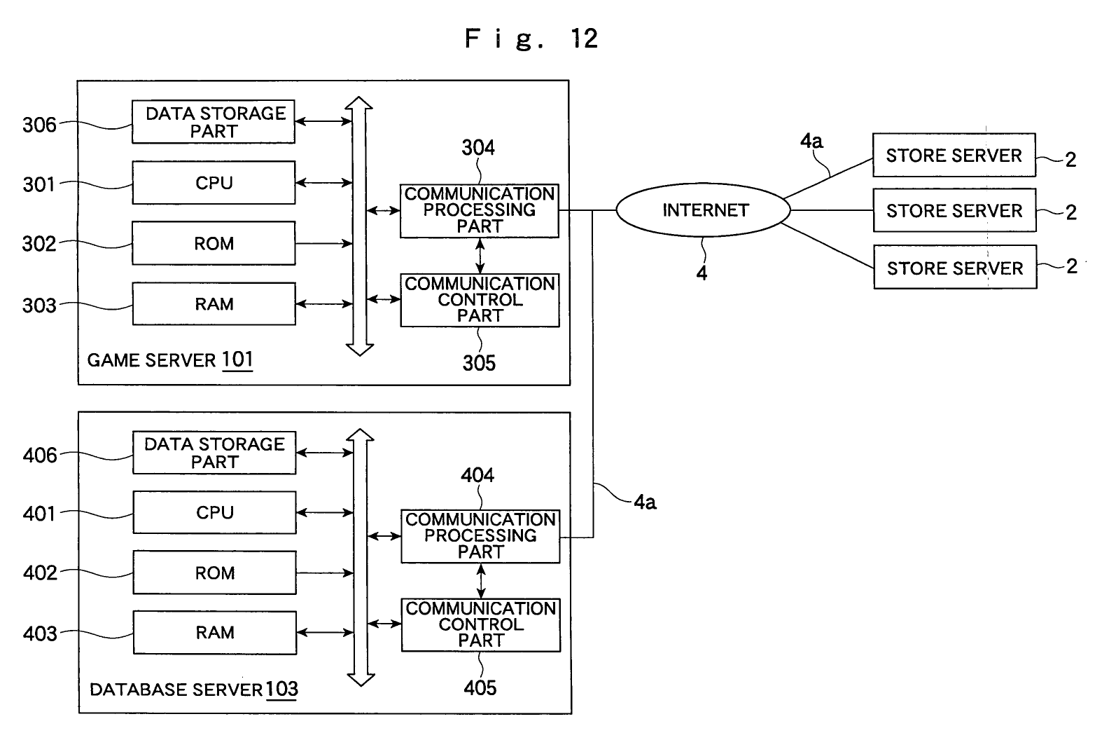

The game server 101 is disposed in order to run the labyrinth combat game. As shown in FIG. 12, it has a CPU 301, ROM 302, RAM 303, a communication processing part 304, a communication control part 305, and a data storage part 306. Then, in the game server 101, the CPU 301 is operated in accordance with a program stored in the ROM 302 as well as reads and writes data to the RAM 303, whereas the communication control part 305 operates the communication processing part 304 in accordance with the instruction of the CPU 301.

The game server 101 sends and receives data with each of the store servers 2 through the Internet 4. Then, it receives entry data, described later, that is sent from each of the game machines 1, updates the acceptance of participation (entry) to the labyrinth combat game by the player and participation information of the player, determines a player to be a combat opponent, and sends the result to the database server 103.

The game server 102 is disposed in order to run another game, having the same configuration, but stored data and programs are varied as compared with the game server 101.

The database server 103 has a CPU 401, ROM 402, RAM 403, a communication processing part 404, a communication control part 405, and a data storage part 406. Then, in the database server 103, the CPU 401 is operated in accordance with a program stored in the ROM 402 as well as reads and writes data to the RAM 403, whereas the communication control part 405 operates the communication processing part 404 in accordance with the instruction of the CPU 401 to send and receive data with each of the store servers 2 through the Internet 4. The data storage part 406 stores a player ID, a password used for authentication of the player, a type of game, and game data. The player ID is read out of the ID card 17 and sent from the game machine 1.

Furthermore, as described later, to the database server 103, each of the players sets the figure 40 that that player uses on the authentication unit 15 in the game machine 1 and allows the figure ID to be read, and then the figure ID corresponding to the read figure 40 is sent from the game machine 1. In the database server 103, an ID management file is formed in the data storage part 406, which can store the corresponding multiple figure IDs as associated with a single player ID sent from the game machine 1. The ID management file manages the player and the figures used by that player. The ID management file is used in authentication of the player and authentication of the figure, described later.

Game data contains data unique to the characters that features each of the characters on multiple characters shown in the labyrinth combat game (character ability values including costumes, costume color, defense parameters, attack parameters and attack areas of each of the characters, and information about special abilities; hereinafter, they are called “figure information”), and contains data indicating history of the labyrinth combat game by each of the players. The game data is sent from the database server 103 to the game machine 1, and used in the labyrinth combat game (the details of operation of the game machine).

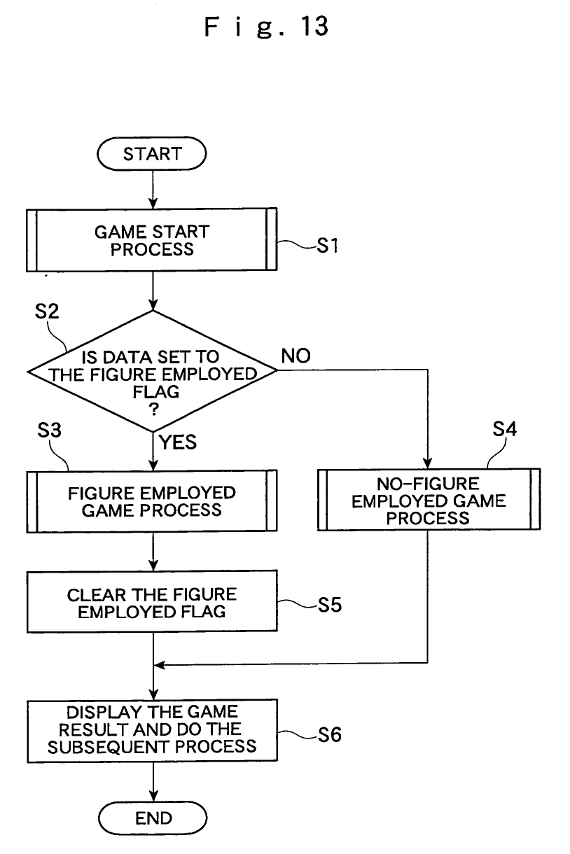

Next, the details of operation of the game machine 1 having the configuration above will be described with reference to flow charts shown in FIGS. 13 to 19. In addition, in the description below, an example is taken for explanation that four game machines 1 among eight game machines 1 placed in the game store A are operated by individual players to play the same labyrinth combat game.

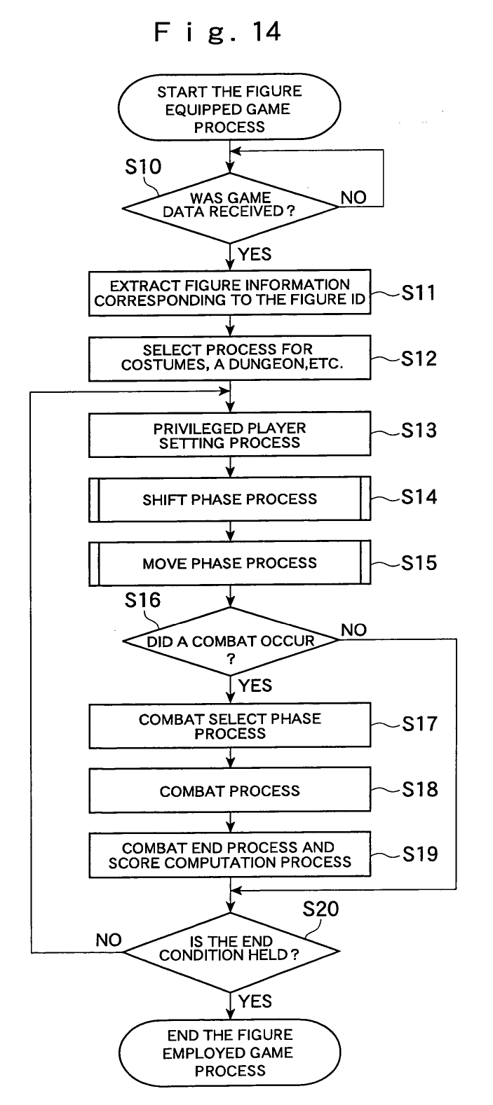

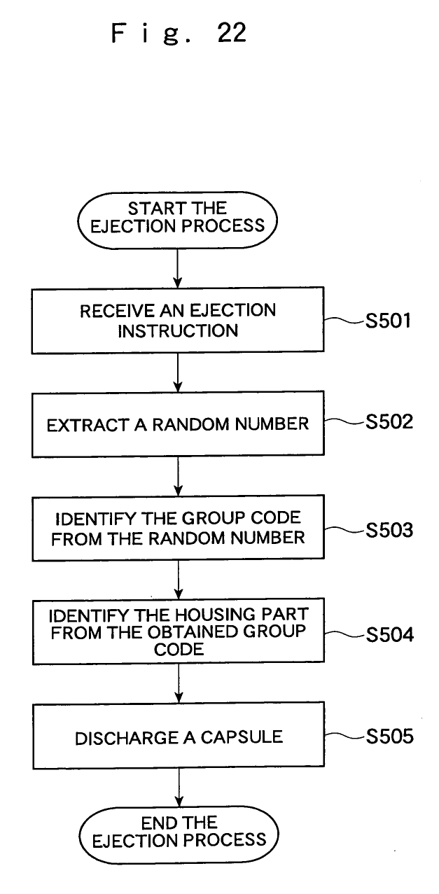

FIG. 13 is a flow chart illustrating the operation procedures of a game process from the start to the end of the game in each of the game machines 1. In addition, in FIG. 13, and FIG. 14 to FIG. 22, described later, Step is abbreviated as S. In the description below, a single game machine 1 among four machines operated by four players is taken as an example for explanation.

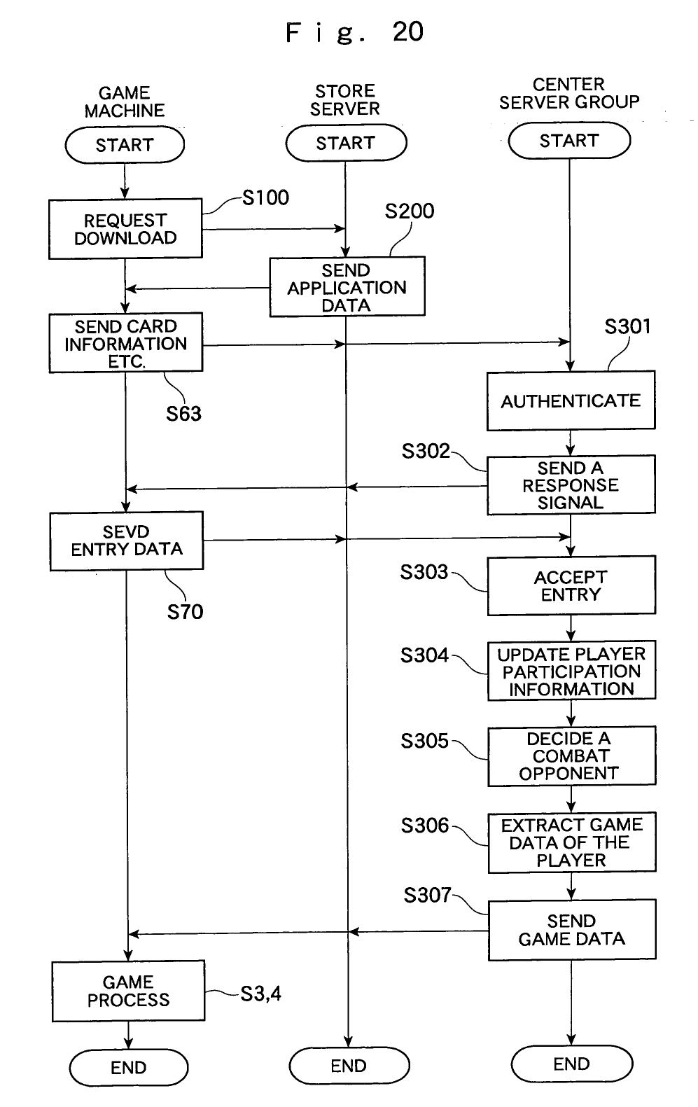

A game machine 1 sends a download request for application data to the store server 2 when power is turned on (Step 100, described later), whereas when the store server 2 receives the download request, it sends application data to the game machine 1 that has sent the download request (see FIG. 20).

When the game machine 1 receives application data, it stores the application data in the RAM 33. Then, in the game machine 1, the main CPU 32 reads the application data, it operates as a game progress control portion according to the invention, it moves the labyrinth combat game forward in accordance with the operation input by a player. Each of the game machines 1 displays game images on the main display 11 through the store server 2 and the center server group 5 as synchronize with each other.

At this time, when each of the game machines 1 starts the game process, it proceeds to Step 1 to perform a game start process, described later, including inputting a coin, inserting an ID card, and a character creation process. At Step 2, it determines whether a predetermined item of data is set to a figure employed flag, described later, (with the flag set) from the result of the game start process. It branches the process to Steps 3 and 4 depending on the determined result (to Step 3 when the figure employed flag is set, and otherwise to Step 4), and performs any one of the processes. When the figure employed flag is cleared at Step 5 subsequent to Step 3, it proceeds to Step 6. It displays the game result (combat result) such as combat scores, whereas it performs the subsequent process to send data indicating the combat result to the database server 103 through the store server 2 in order to update game data in the database server 103, and then ends the process.

In this manner, in the game machine 1, the labyrinth combat game can be played in any one of the figure employed mode and a no-figure employed mode. However, in the figure employed mode, the game details are beneficial to the player more than the no-figure employed mode (the details will be described later). (Figure employed game process).

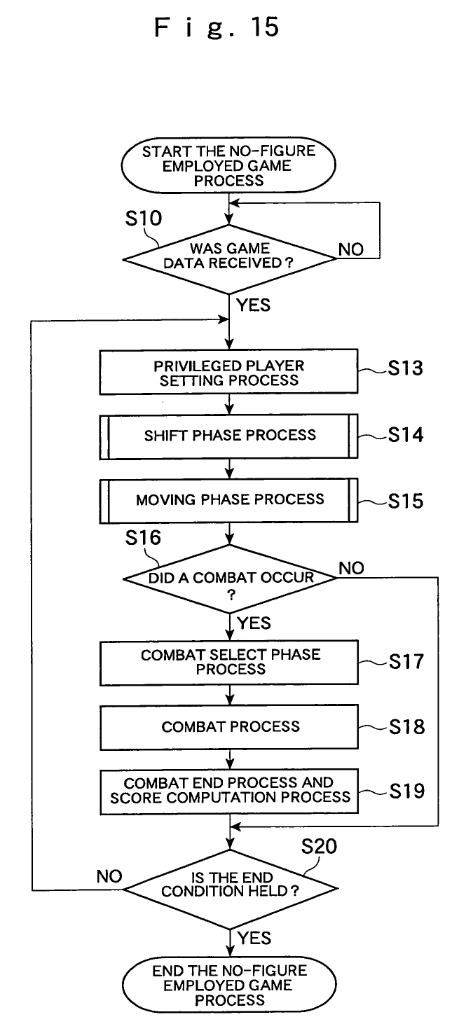

The game machine 1 performs the figure employed game process and a no-figure employed game process along flow charts shown in FIGS. 14 and 15. FIGS. 14 and 15 are flow charts illustrating the operation procedures of the game process (figure employed game process) in the figure employed mode, and the game process (no-figure employed game process) in the no-figure employed mode.

When the game machine 1 starts the figure employed game process, it proceeds to Step 11 shown in FIG. 14. It waits until it receives game data from the store server 2. When it receives game data, it temporarily stores the game data in the RAM 33, proceeds to Step 11, and the main CPU 32 extracts figure information corresponding to the figure ID of a figure 40 used by a player. In this manner, the extracted figure information is used to do the game process in the figure employed mode. Subsequently, it proceeds to Step 12, and performs a select process for costumes and a dungeon.

Here, the main CPU 32 sets the select range of the following items wider than that of the no-figure employed game process on the main display 11. In this case, a select screen, not shown, is displayed on the main display 11, and the player can select the flowing items. More specifically, the player can select attributes (costumes that the character wears in the embodiment) of the character corresponding to the figure 40 newly set and authenticated (or already authenticated) and a dungeon used in the labyrinth combat game.

When the player touches on the main display 11 by the finger to select the desired costumes and dungeon, information indicating the choice is inputted from the touch panel 11a to the main CPU 32. Since Step 12 is a process in the figure employed mode, costumes can be selected from multiple types (for example, three types), and the dungeon can be selected from two ways, a normal form and a special form. On the other hand, in the no-figure employed game process, it has no process equivalent to Step 12; the former is only default costumes set every character, and the latter is only the normal form.

Subsequently, it proceeds to Step 13 to perform a privileged player decision process. Here, a player who can shift the labyrinth (shift privileged player), described later, is decided among the players participating in the labyrinth combat game (four players in the embodiment). Each of the players is decided in tern as the shift privileged player.

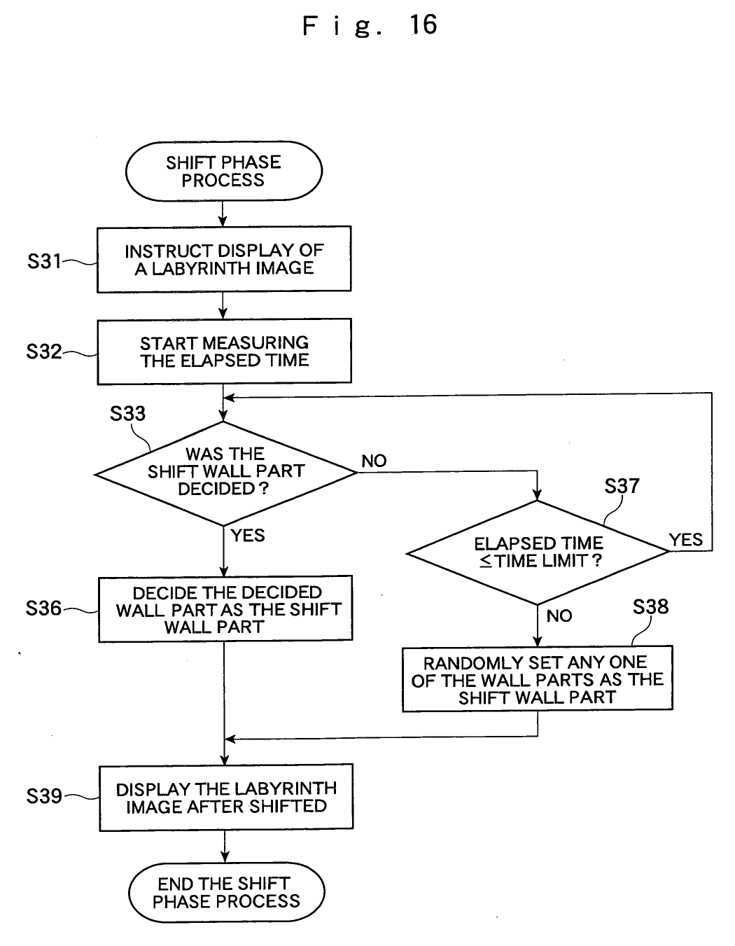

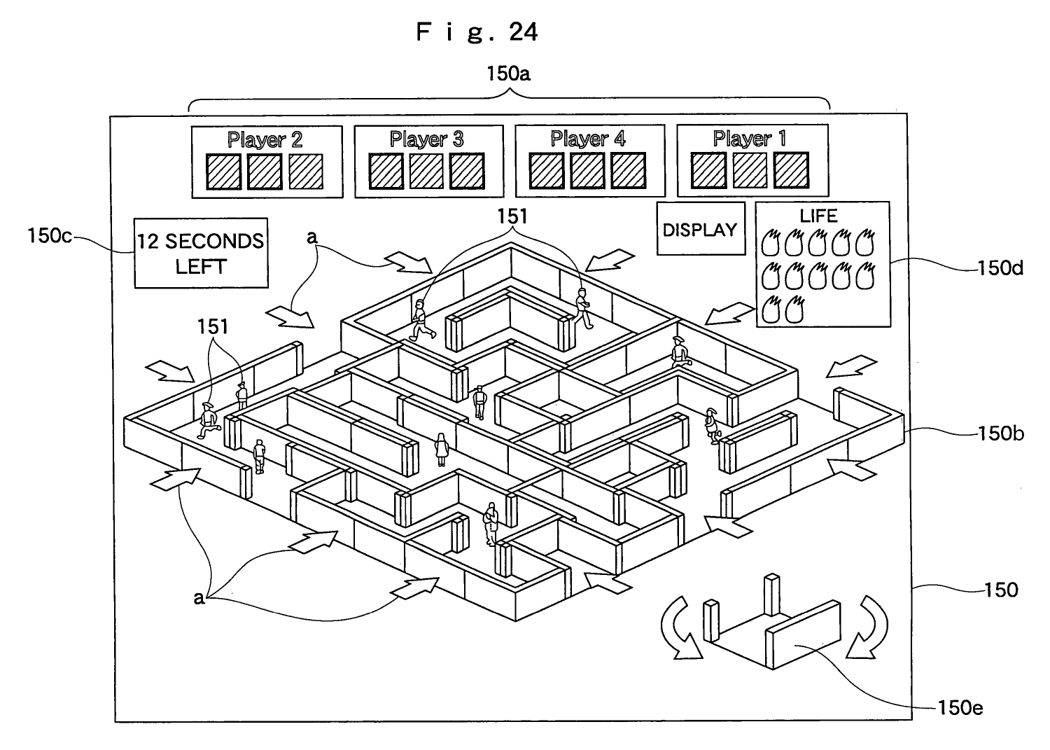

At subsequent Step 14, a shift phase process is performed. The shift phase process is done along a flow chart shown in FIG. 16. When the shift phase process is started, the main CPU 32 proceeds to Step 31, it instructs the image control circuit 71 to display a labyrinth image 150 as shown in FIG. 24 on the main display 11. The labyrinth image 150 has a player display part (players 1, 2, 3 and 4) 150a which displays the shift privilege owned by four players and the order of attack priorities, and a labyrinth display part 150b which displays the image of a labyrinth formed of multiple wall parts; images of multiple characters 151 are displayed in the labyrinth. Furthermore, it includes the indication of remaining time using set-up time and a first elapsed time, described later, as an input promotion image, and has a timer display part 150c which encourages the player to enter operation input, further having a life display part 150d and a description display part 150e which explains the way to move the wall part. The timer display part 150c is displayed on the main display 11 by the main CPU 32, and the numeric value to be displayed is reduced as the first elapsed time is increased.

Subsequently, proceed to Step 32, and the main CPU 32 starts measuring the first elapsed time. The first elapsed time indicates the elapsed time from the time (input start time) when the player is allowed to make operation input (progress operation input or decision operation input) indicating that the player decides a wall part (shift wall part) to be a shift target that its position is shifted to the time when the player touches a desired arrow a to make progress operation input or decision operation input. At subsequent Step 33, the main CPU 32 determines whether the shift wall part has been decided. When the shift wall part has been decided, proceed to Step 36, otherwise proceed to Step 37. At Step 36, the main CPU 32 sets the decided wall part to the shift wall part, and decides the action of the character (to shift the wall).

On the other hand, proceeding from Step 33 to Step 37, it is determined whether the first elapsed time is within the time limit to decide the shift (15 seconds in the embodiment). When the first elapsed time is within the time limit to decide the shift, return to Step 33, otherwise proceed to Step 38, and any one of wall parts is randomly set to the shift wall part by using the extracted random number from the sampling circuit 36. Then, proceed to Step 39 to display the shifted labyrinth image, and the shift phase process is finished.

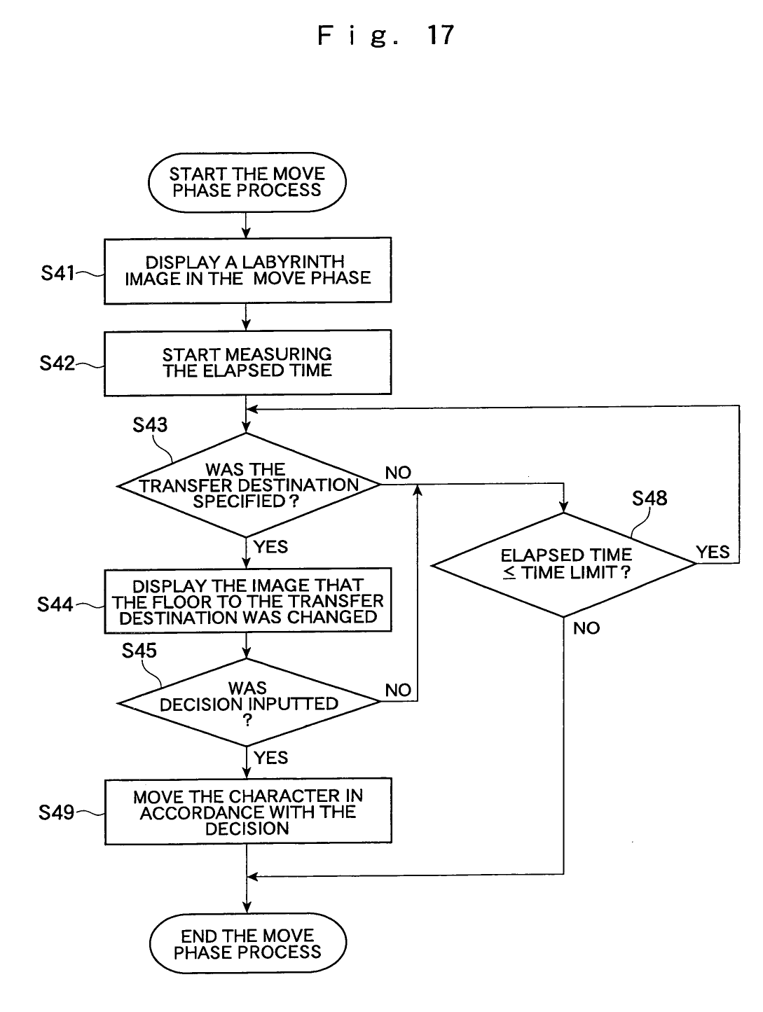

Subsequently, proceed to Step 15 to perform a move phase process. The move phase process is performed along a flow chart shown in FIG. 17. In addition, the move phase process is a process that is run in all the game machines 1 doing the same labyrinth combat game at the same time.

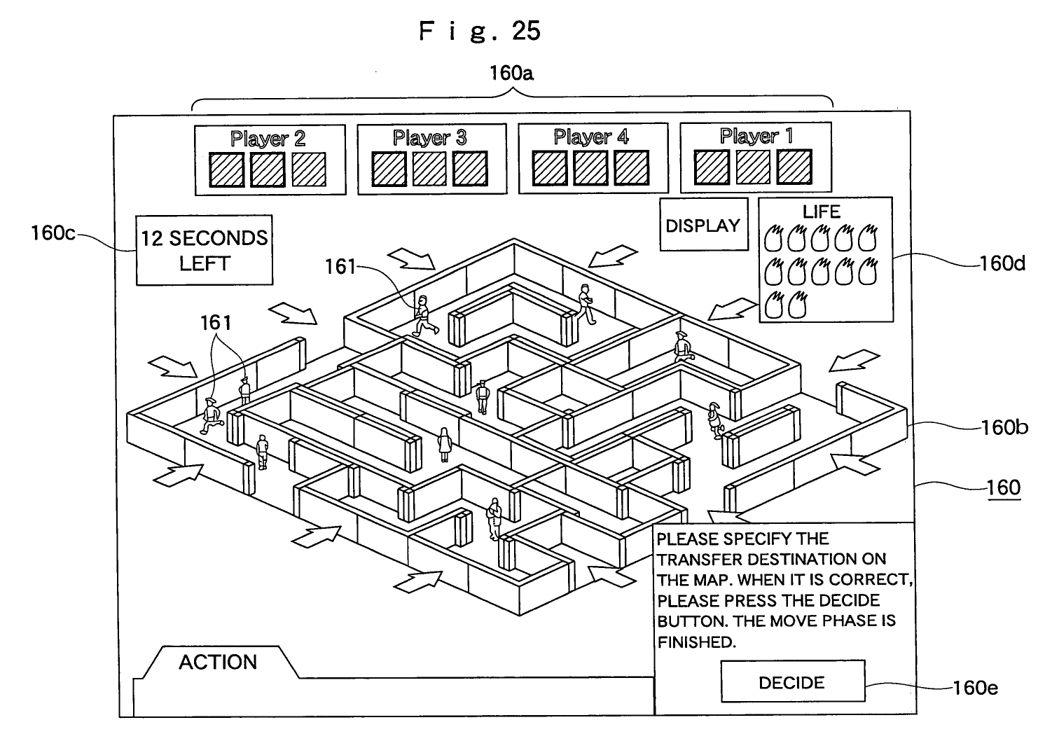

When the move phase process is started, the main CPU 32 proceeds to Step 41, and instructs the image control circuit 71 to display a labyrinth image 160 in the move phase on the main display 11 as shown in FIG. 25.

After that, proceed to Step 42, the main CPU 32 starts measuring a second elapsed time. The second elapsed time indicates the elapsed time from the time when the player is allowed to make operation input (specifying a transfer destination) to specify the transfer destination of the character of that player to the time when the player specifies the transfer destination, touches a transfer destination specification display part 160e, and then makes operation input (progress operation input or decision operation input) to move the game forward. At subsequent Step 43, the main CPU 32 determines whether the transfer destination has been specified. When the transfer destination has been specified, proceed to Step 44, otherwise proceed to Step 48. Proceeding to Step 44, an image (not shown) that the display color of the floor to the transfer destination is changed is displayed to clearly show the transfer destination, and then proceed to Step 45. Then, it is determined whether the player has been touched a decision button of the transfer destination specification display part 160e (to decide the transfer destination). When the player has touched, proceed to Step 49, otherwise proceed to Step 48.

Proceeding to Step 48, it is determined whether the second elapsed time is within the time limit to decide the transfer destination (30 seconds in the embodiment). When the second elapsed time is within the time limit to decide the transfer destination, return to Step 43, otherwise wait for the instruction from the store server 2, described later, to end the move phase process (in this case, the character does not move and waits at the place where it is). Furthermore, at Step 49, what the character to do (the move in the labyrinth) is decided in accordance with the decision at the steps so far, and an image is displayed that the character has moved. Then, the move phase process is finished. In addition, as reward that cannot be obtained in the no-figure employed mode, special cards (such as a teleportation card that allows random moves, and a card that allows passing through a wall) in the move phase process in the figure employed mode.

Here, return to FIG. 14, proceeding to Step 16 subsequent to the move phase process, the main CPU 32 determines whether combat occurs. When combat occurs here, proceed to Step 17 (in the case where multiple characters are in the area on the labyrinth where attack is allowed), whereas when no combat occurs, proceed to Step 20.

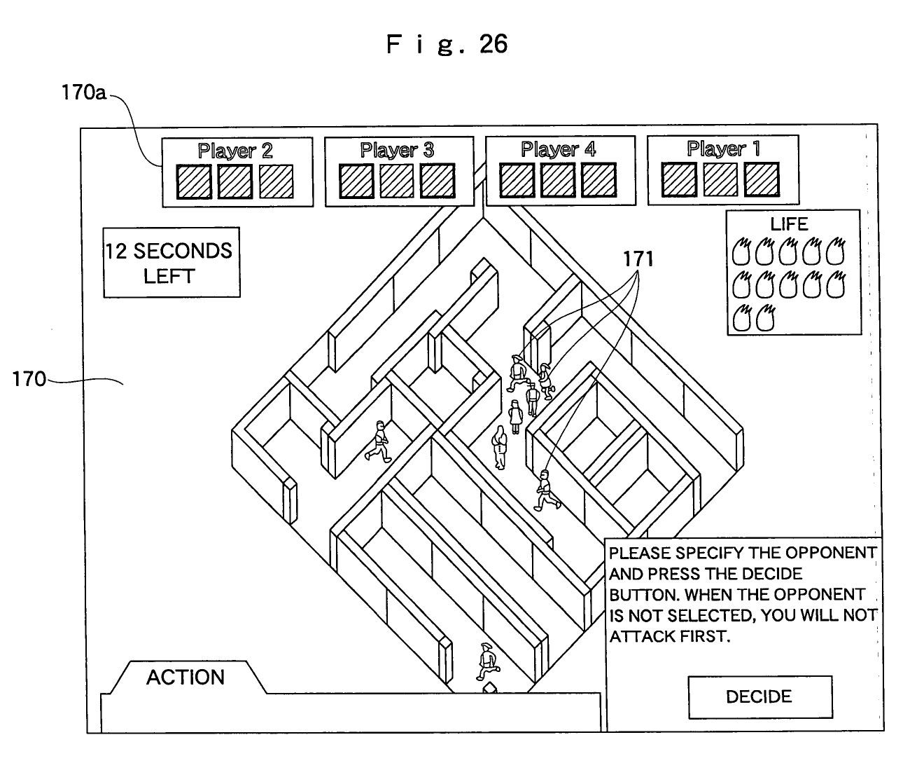

At Step 17, a combat select phase process is performed. Here, the main CPU 32 instructs the image control circuit 71 to display a combat select image 170 on the main display 11 as shown in FIG. 26. With reference to the combat select image 170, each of the players (four players in the embodiment) selects the character to attack, and selects whether to use a technique card showing the techniques of the character, and selects a technique card for use. In addition, the order of attack by each of the characters is based on the shift privileged player.

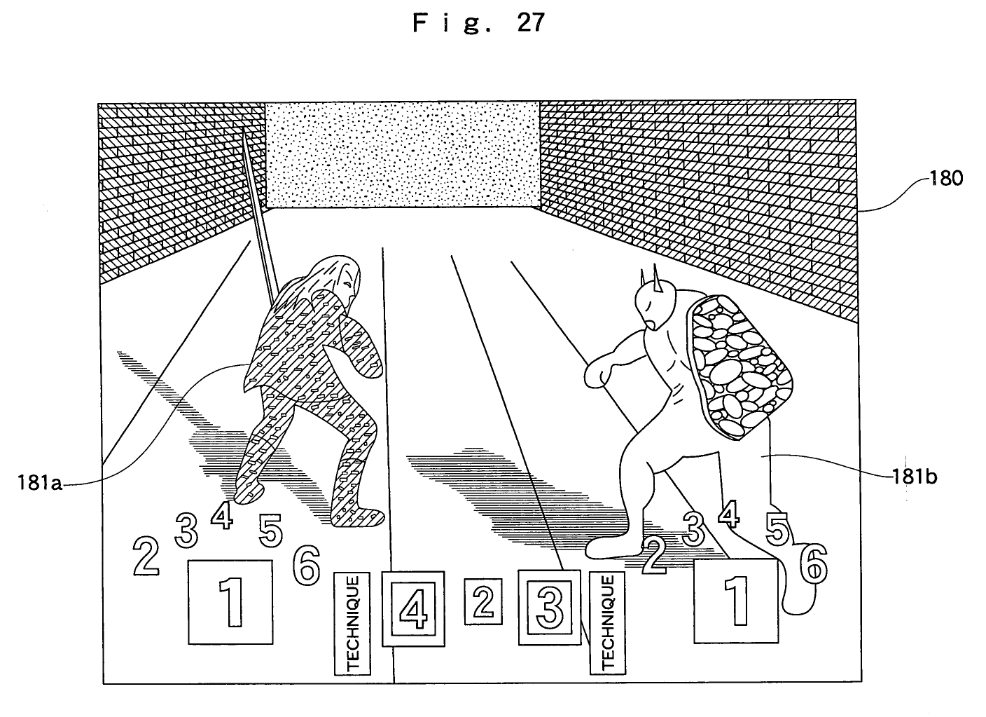

At subsequent Step 18, a combat process is performed. More specifically, offense and defense of each of the characters are specified by figure information, and the attack area is also set. Therefore, attack parameters and defense parameters of the character to fight as an opponent are compared to decide whether each of the characters wins or loses. In this case, a combat image 180 showing that characters 181a and 181b fight against each other is displayed on the sub-display 12 as shown in FIG. 27.

Then, at Step 19, a combat end process and a score computation process are performed. Here, a life is added or subtracted in accordance with the result of the combat process at Step 18 (the type of the character to fight as an opponent and the combat result whether to win or lose the combat), and a title and an orb are given to the character, or deprived (in the figure employed mode, various titles are given in accordance with the acts of the character, “conqueror”, “master”, “specialist” and so on). At subsequent Step 20, it is determined whether an end condition is held. When the end condition is held (scores are zero or below), the figure employed game process is finished, otherwise (scores>0) return to Step 13 to repeat the process. The player whose scores are zero or below ends the labyrinth combat game, and the main CPU 32 participates as another character instead. In addition, not shown in the drawing, the player who has no life can recover a fixed amount of life by using a recovery card or by inputting a coin (no-figure employed game process).

In the no-figure employed game process shown in FIG. 15, the process is performed along almost the same flow chart illustrating the figure employed game process shown in FIG. 14. When compared with the figure employed game process, the no-figure employed game process is different in that it does not have Step 12.

In the no-figure employed mode, although the figure is not used to move the game forward, game data is received and stored in the RAM 33 and figure information corresponding to that figure ID is extracted when the response signal includes a figure ID (in the case where there is a figure already authenticated).

Furthermore, since it does not perform Step 12, as described above, it is different from the figure employed mode in that costumes and a dungeon cannot be selected to limit the details of the game as compared with the labyrinth combat game in the figure employed mode. Moreover, the select ranges of various cards that can be selected at Step 15 and technique cards that can be selected at Step 17 are also limited.

Then, although a title is given to the character at Step 19 in accordance with the combat result, only a title of “ronin”, or a masterless samurai is given in the no-figure employed mode even though the combat result is good.

In this manner, in the game machine 1, the game can be moved forward not only in the case where the figure 40 is used but also in the case where the figure 40 is not used. Moreover, when the figure 40 is used, the reward can be obtained that cannot be obtained when no-figure employed is used. Thus, incentive to collect the figure can be given to the player, and entertainment can be offered that makes full use of the characteristics of the nature of the labyrinth combat game. Particularly, when the figure 40 is used to play the labyrinth combat game, there are advantages that the scores of the character corresponding to the figure are increased, offense and defense are grown, and titles are given in accordance with the details of the progress in the game. Therefore, the willingness to repeatedly use the figure is generated in the player to satisfy the player (game start process).

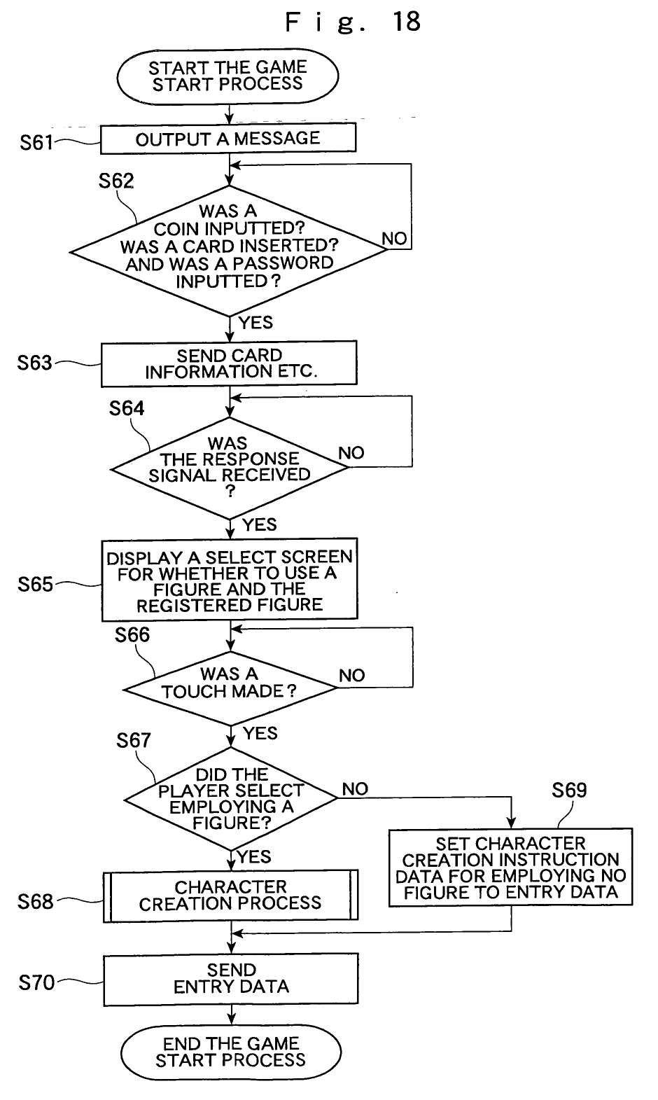

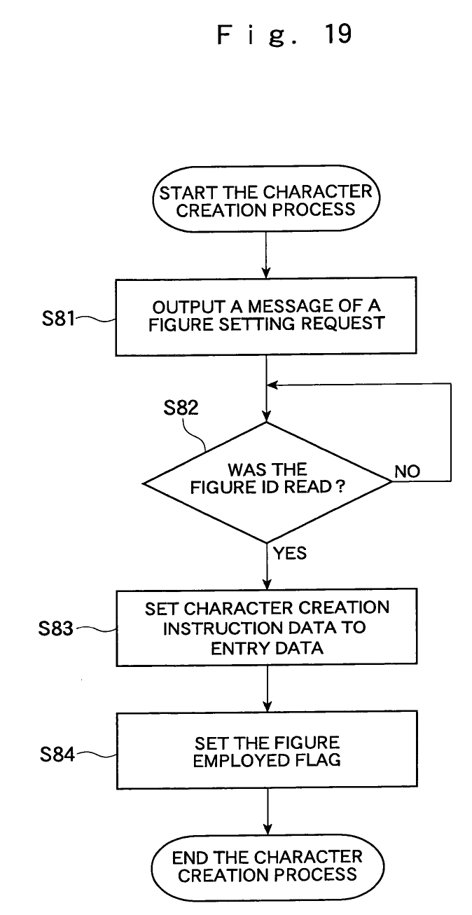

The game start process at Step 1 is performed along a flow chart shown in FIG. 18. FIG. 18 is a flow chart illustrating the operation procedures of the game start process, and FIG. 19 is a flow chart illustrating the operation procedures of a character creation process.

When the main CPU 32 starts the game start process, it proceeds to Step 61, performs a message output process, and instructs the image control circuit 71 to display predetermined messages (a coin input request, an ID card insertion request, and a password input request) on the main display 11. Subsequently, it performs the processes at Steps 62 and 63.

In order to start the game, the player inputs a coin from the coin input port 6 as well as inserts an ID card 17 into the card slot 18, and inputs a password with the control unit 19. Then, the detection signal for the inputted coin is inputted from the coin sensor 16a to the main CPU 32, and card information stored in the ID card 17 is inputted from the card reader 18a. Furthermore, the password is inputted from the control unit 19, and all the inputs are done to proceed to Step 63. The main CPU 32 instructs the communication control part 21 to operate the communication processing part 22 to send the read card information and the inputted password to the store server 2.

At subsequent Step 64, the CPU waits until it receives a response signal, described later, from the center server 5. When it receives the response signal, it proceeds to Step 65. At Step 65, the CPU determines from the response signal whether the figure is equipped and whether authentication (registration) has been already done, and instructs the main display 11 to display a select screen that allows selection of any one of various selectable characters. At subsequent Step 66, the CPU waits until a touch is made on the touch panel 11a. When a touch is made, it proceeds to Step 67. At Step 65, the CPU determines whether employing the figure has been selected. Here, when employing the figure has been selected, proceed to Step 68, otherwise proceed to Step 69. Proceeding to Step 68, the character creation process, described later, is done. At Step 69, the character creation instruction (the character creation instruction with no-figure employed) data by employing no figure is set to entry data, described later, and both Steps 68 and 69 proceed to subsequent Step 70. More specifically, at Step 67, in both cases where a figure is used for the first time and where there is the figure already authenticated and another figure different from the authenticated figure is used, when the player selects employing the figure, proceed to Step 68 to do the character creation process. Moreover, in the cases where no figure is used from the beginning and where there is the figure already authenticated but that figure is not used, when the player selects employing no figure, proceed to Step 69.

Subsequently, proceeding to Step 68, the main CPU 32 performs the character creation process along a flow chart shown FIG. 19. When it starts the process, it proceeds to Step 81 and performs a figure setting request message output process. Here, the main CPU 32 instructs the image control circuit 71 to display on the main display 11 a message requesting that the figure 40 is mounted on the authentication unit 15 to set the figure ID for read (for example, “please set the base of the figure to the authentication unit on the control panel. When the authentication of the figure is started, the authentication unit is lit up. Thus, please leave the figure on the base until the light goes out.”). At subsequent Step 82, the CPU waits until the figure ID is finished to read. When the player sets the figure 40 to the authentication unit 15 in accordance with the message shown, the authentication unit 50 reads the figure ID stored in the IC chip 44 of the figure 40, and inputs it to the main CPU 32. Then, proceed to Step 71, and character creation instruction data including the figure ID read by the main CPU 32 is set to entry data. At subsequent Step 84, a predetermined item of data (“1” in the embodiment) is set to a figure employed flag indicating that the figure ID of the figure 40 is read by the authentication unit 15 (setting the figure), Step 84 is done, and then the character creation process is finished.

Proceeding to Step 70, the main CPU 32 instructs the communication control part 21 to operate the communication processing part 22 to send entry data to the store server 2. When Step 70 is finished, the game start process is ended.

In this manner, the game machine 1 sets a predetermined item of data to the figure employed flag. Once the figure is set, entry data including character creation instruction data is sent to the database server 103 through the store server 2. The figure ID is stored in the ID management file in the database server 103 as associated with the player ID unique to the player who has set the figure, and is used for determining whether the figure has already been authenticated. Furthermore, the determined result whether the figure has already been authenticated by the ID management file is sent from the database server 103 as the response signal. Thus, the player can select the character corresponding to the authenticated figure to play the labyrinth combat game. However, when the player does not set the figure, the figure employed flag is not set as well. Therefore, even though the figure has already been authenticated, it is necessary to set the figure 40 to the authentication unit 15 and to read the figure ID in order to play the labyrinth combat game in the figure employed mode. Then, when it is set, figure information corresponding to the read figure ID is generated in the database server 103 to play the labyrinth combat game even though the figure 40 is not repeatedly set.

On the other hand, in the game machine 1, the store server 2 and the center server group 5, the processes are implemented in the order shown in FIG. 20 in accordance with the processes above. FIG. 20 is a sequence chart illustrating operation sequences done among the game machine 1, the store server 2 and the center server group 5.

In the game machine 1, it sends a download request to the store server 2 at Step 100 to download application data, and it sends card information at Step 63 as described above. Then, in the center server group 5, it proceeds to Step 301, and it performs the authentication process in which the CPU 401 in the database server 103 uses the card information and the password sent from the game machine 1 to determine whether the player and the figure are registered by referring to the ID management file. When they have been registered, it proceeds to Step 302 as they are authenticated, and sends the response signal indicating the authenticated result to the game machine 1. In this case, in the database server 103, it performs the same authentication process with respect to the game machines 1, eight machines are disposed in each of the stores A and B.

Furthermore, in the game machine 1, it sends entry data as shown at Step 70. Then, in the center server group 5, it proceeds to Step 303, and the game server 101 accepts entry of the player by using entry data from each of the game machines 1. Moreover, at subsequent Step 304, it registers or updates the figure to the ID management file and creates or updates figure information by using the update of participation information of the player and the figure ID corresponding to character creation instruction data (the figure ID includes figure IDs for a newly registered figure, not authenticated, and the authenticated figure to be again authenticated). At subsequent Step 305, it decides the players to fight as an opponent (four players in the embodiment). Furthermore, at Step 306, the database server 103 extracts game data of each of the players to fight as opponents to proceed to Step 307, and sends the extracted game data to the store server 2. In the store server 2, when it receives game data, it sends the data to each of the game machines 1.

During the operation of the game machine 1 described in detail, the main CPU 32 inputs instruction information indicating an instruction to supply the figure 40 to the communication processing part 22 at timing when a predetermined condition is held in progress of the labyrinth combat game. When the instruction information is inputted to the communication processing part 22, the communication processing part 22 sends an instruction to discharge the FIG. 40 to the figure feeder 6B at timing when the instruction information is inputted. Here, a predetermined condition in game progress is the conditions to win a specific combat opponent, to obtain a predetermined number of orbs, and to attain a fixed level of the game progress such as scores and performance in the game. In addition, the instruction information indicating the instruction to supply the figure 40 includes the group code described above as housing part identification information. The ejection instruction including the group code is sent from the game machine 1 to the figure feeder 6B (the details of operation of the figure feeder).

When the figure feeder 6B receives the ejection instruction from the game machine 1 by the communication processing part 130, the main CPU 121 of the figure feeder 6B discharges a single capsule 47 from the ejection unit 54.

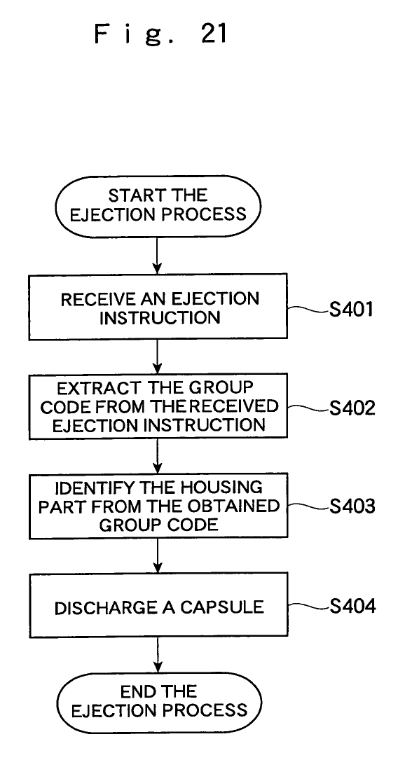

The process flow will be described in detail with reference to FIG. 21. When the figure feeder 6B first receives the ejection instruction from the game machine 1 by the communication processing part (receiving portion) 130 at Step 401, the main CPU 121 extracts the group code included in the ejection instruction at Step 402. At subsequent Step 403, The CPU specifies the housing part 60 corresponding to the group code among eight housing parts 60 (in the specified housing part 60 here, the figure in the group specified (identified) by the group code is housed). Then, at Step 404, the main CPU 121 operates as an ejection control portion according to the invention, and outputs an open control signal to the drive control circuit 70a so that the figure housed in the specified target housing part 60 is discharged, the open control signal which opens the block plate 65 of the target housing part 60 (for example, the ejection group code of the target housing part 60 is “B”, in the case of the block plate 652). Subsequently, the drive control circuit 70a drives the motor corresponding to the open control signal (for example, the motor M2) to open the block plate 652. Then, the capsule 47 most closely located at the block plate 652 of the slope 62a rolls out of the discharge port 64, and passes through the chute 66 for ejection to the capsule output port 56 as shown in FIG. 10.

As described above in detail, in the game system 8 (that is, the game machine 1 and the figure feeder 6B), the main CPU 32 of the game machine 1 sends the ejection instruction of the figure 40 from the communication processing part 22 of the game machine 1 to the figure feeder 6B at timing when a predetermined condition is held in game progress of the labyrinth combat game. Then, when the communication processing part 130 of the figure 40 receives the ejection instruction, the main CPU 121 (ejection control portion) of the figure 40 discharges the capsule 47 containing the figure 40 from the ejection unit 54. More specifically, since the game system 8 can offer the figure 40 to the player when a predetermined condition is held on the labyrinth combat game, it implements the feed form of the figure 40 different from the traditional game that only sells figures. In this manner, the way that a predetermined condition is held on the labyrinth combat game and thus the figure 40 is supplied can offer the figure 40 to the player as a bonus of the game.

In addition, the group code included in instruction information may be a code corresponding to a predetermined condition of the labyrinth combat game. More specifically, the main CPU 32 may include the group code of the figure (for example, a monster figure) corresponding to a monster character in instruction information and may input it to the communication processing part 22 when the character of the player has won the specific character (monster character) as a predetermined condition. In this case, the communication processing part 22 sends the ejection instruction including the group code of the monster figure, and the figure feeder 6B in which the monster figure is housed in the housing part 60 specified by the sent group code discharges that monster figure. In this case, the figure 40 corresponding to that predetermined condition can be offered to the player as a bonus that a predetermined condition is held in progress of the labyrinth combat game.

Besides, in the game machine 1, in addition to the form that the group code is used as housing part identification information described above, a level code can be used that indicates the levels of strength of figures can be used. Hereinafter, the form using the level code will be described.

When the level code is used as housing part identification information, the figure ID includes the level code (I to VIII) that indicates the levels of strength of the individual figures. Then, in eight housing parts 60 of the figure feeder 6B, the figures 40 are classified and housed at every figure having the same level code. Subsequently, when the character of the player satisfies a predetermined condition to raise the level on the labyrinth combat game (for example, a predetermined number of dungeon is cleared), the main CPU 32 of the game machine 1 includes the level code of the next level to the level code detected from the figure ID of the figure being used by the player in instruction information as housing part identification information.

A specific example is taken. When the player sets the figure 40 to the authentication unit 50 at starting the game and the figure ID is inputted to the main CPU 32, the main CPU 32 stores the level code “III” included in the figure ID in a predetermined housing part (for example, the RAM 33). Then, when the character of the player satisfies a predetermined condition to raise the level, the main CPU 32 inputs instruction information including the level code “IV” as housing part identification information to the communication processing part 22 based on satisfying that condition, and the ejection instruction including the housing part identification information is sent from the game machine 1 to the figure feeder 6B. Subsequently, the figure feeder 6B receives the ejection instruction, and discharges the figure 40 from the housing part 60 corresponding to the housing part identification information (that is, the level code “IV”). In this manner, the level code is adopted as the housing part identification information, and thus the figure stronger (of higher level) than the figure being used by the player can be offered to the player as a bonus to raise the level of the character of the player in the labyrinth combat game.

In addition, the ejection instruction is sent from the game machine 1 to the figure feeder 6B not only when a predetermined condition is held in game progress of the labyrinth combat game but also when the player purchases the figure 40 with the game machine 1. More specifically, at a predetermined step during the game start process shown in FIG. 18, the game machine 1 accepts a figure purchase instruction (feed instruction) from the player through the touch panel (accepting portion) 11a. Then, when the figure purchase instruction is accepted through the touch panel 11a, the communication processing part 22 of the game machine 1 immediately sends the ejection instruction of the figure 40 to the figure feeder 6B. In this manner, in the game system 8, the figure 40 may be offered to the player who wants to purchase the figure 40. Besides, the figure purchase instruction and the ejection instruction include the group code of the figure 40 as similar to the feed instruction described above. The figure 40 in the group that the player desires is selectively discharged from the ejection unit 54 of the figure feeder 6B.

In this manner, in the game system 8, the communication processing part 22 of the game machine 1 sends the ejection instruction to the communication processing part 130 of the figure feeder 6B, and thus the figure purchase instruction is accepted from the player to sell the figure 40 as well as the figure 40 can be offered in various feed forms such as when a predetermined condition is held on the labyrinth combat game. Then, when the group code is included in the ejection instruction as described above, the figure feeder 6B can selectively provide the figure 40 in a specific group for the player.

In addition, in the game system 8, the figure 40 is exemplified for description as the game item. However, the invention can also be applied to the case where the game item different from the figure 40 is used. For example, a card-shaped game card and a cassette may be used on which pictures and patterns corresponding to the character are depicted and ID information is stored. Furthermore, the game machine 1 which can play the labyrinth combat game is exemplified for description. However, it can also be applied to the game machine that can play other image games. For example, they are the game machines for games that multiple players such as baseball and soccer players and that can use figures and cassettes corresponding to each of the multiple players to simulate team play. Moreover, in the game machine 1, it has the main display 11 and the sub-display 12 which display game images, but the main display 11 and the sub-display 12 may be separately disposed.

Besides, in the embodiment described above, the form is illustrated that the main CPU inputs instruction information to the communication processing part at timing when a predetermined condition is held in game progress. However, for the timing to input instruction information, a predetermined time lag can be set such as timing after the game is completed and timing after the other predetermined conditions are held, in consideration of the game properties and directing. Similarly, for the timing that the communication processing part sends the ejection instruction to the figure feeder, a predetermined time lag can also be set, not limited to the timing right after instruction information is inputted, in consideration of the game properties and directing. Furthermore, for the timing that the communication processing part sends the ejection instruction to the figure feeder when the game machine accepts figure purchase information from the player through the touch panel, a predetermined time lag can also be set, in consideration of the game properties and directing.

In addition, the number of the housing parts is not limited to eight, which can be increased or decreased freely. Besides, for the categories of the figures to be housed in the housing parts, it can be categorized depending on various attributes held by the figures, other than the categories of the group code and the level code.

What is claimed is:

1. A game system comprising:
a game item feeder having:
a housing unit which houses a game item storing identification information; and
an ejection unit which discharges the game item, and
a game machine which reads identification information from the game item and plays an image game using a game image corresponding to the game item,
wherein the game machine includes:
a sending portion which sends an ejection instruction of the game item to the game item feeder, and
the game item feeder includes:
a receiving portion which receives the ejection instruction from the game machine; and
an ejection control portion which allows the ejection unit to discharge the game item when the receiving portion receives the ejection instruction.

2. The game system according to claim 1,
wherein the housing unit of the game item feeder has multiple housing parts which house the game item,
the ejection instruction sent by the sending portion of the game machine includes housing part identification information that identifies a specific housing part among the multiple housing parts, and
the ejection control module allows the ejection unit to discharge the game item housed in the housing part specified by housing part identification information when the receiving module receives the ejection instruction.

3. The game system according to claim 1,
wherein the game machine further comprises an accepting portion which accepts a feed instruction of the game item from a player, and
the sending portion of the game machine sends the ejection instruction to the game item feeder based on acceptance of the feed instruction by the accepting portion.

4. The game system according to claim 2,
wherein the game machine further comprises an accepting module which accepts a feed instruction of the game item including the housing part identification information from a player, and
the sending module of the game machine sends the ejection instruction of the game item including the housing part identification information to the game item feeder based on acceptance of the feed instruction by the accepting module.

5. The game system according to claim 1,
wherein the game machine further comprises a game progress control module which controls progress of the image game,
the game progress control module inputs instruction information indicating a feed instruction of the game item to the sending module based on establishment of a predetermined condition in game progress, and
the sending module sends the ejection instruction to the game item feeder based on input of the instruction information from the game progress control module.

6. The game system claim 3,
wherein the game machine further comprises a game progress control module which controls progress of the image game,
the game progress control module inputs instruction information indicating a feed instruction of the game item to the sending module based on establishment of a predetermined condition in game progress, and
the sending module sends the ejection instruction to the game item feeder based on input of the instruction information from the game progress control module.

7. The game system according to claim 2,
wherein the game machine further comprises a game progress control module which controls progress of the image game,
the game progress control module inputs instruction information including the housing part identification information and indicating a feed instruction of the game item to the sending module based on establishment of a predetermined condition in game progress, and
the sending module sends the ejection instruction of the game item including the housing part identification information to the game item feeder based on input of the instruction information from the game progress control module.

8. The game system according to claim 4,
wherein the game machine further comprises a game progress control module which controls progress of the image game,
the game progress control module inputs instruction information including the housing part identification information and indicating a feed instruction of the game item to the sending module based on establishment of a predetermined condition in game progress, and
the sending module sends the ejection instruction of the game item including the housing part identification information to the game item feeder based on input of the instruction information from the game progress control module.

9. The game system according to claim 7,
wherein the instruction information includes the housing part identification information of the housing part which houses the game item corresponding to a predetermined condition among the multiple housing parts.

10. The game system according to claim 8,
wherein the instruction information includes the housing part identification information of the housing part which houses the game item corresponding to a predetermined condition among the multiple housing parts.
